(19) United States
(12) Patent Application Publication
(10) Pub. No.: US 2024/0405493 A1
(43) Pub. Date: Dec. 5, 2024

(54) ROBUST CONNECTOR AND ACTIVE CABLE THEREWITH

(71) Applicant: Amphenol East Asia Limited (Hong Kong), Kowloon (HK)

(72) Inventors: Lo-Wen Lu, Taoyuan City (TW); Sheng-Fen Sang, Taoyuan City (TW)

(73) Assignee: Amphenol East Asia Limited (Hong Kong), Kowloon (HK)

(21) Appl. No.: 18/731,099

(22) Filed: May 31, 2024

(30) Foreign Application Priority Data
Jun. 2, 2023 (TW) 112205580
Jun. 2, 2023 (TW) 112205581
Jun. 2, 2023 (TW) 112205582
Aug. 9, 2023 (TW) 112208427

(51) Int. Cl. H01R 27/02; H01R 12/72

(52) U.S. Cl. CPC H01R 27/02; H01R 12/721

(57) ABSTRACT

Robust connectors and active connectors therewith are provided. A receptacle connector includes first and second terminal assemblies disposed in a same housing slot and separated from each other by a predetermined space. Such a configuration enables the first and second terminal assemblies to be configured according to physical dimensions of various interface standards while simultaneously satisfying respective electrical requirements. The receptacle connector is connected to an end of a cable directly or through a plug connector. The plug connector comprises a circuit board having first and second groups of contact pads aligned in a row and spaced from each other so as to respectively mate with the first and second terminal assemblies of the receptacle connector. The circuit board has a third group of contact pads configured more suitable for attaching the cable. The third group is electrically coupled to the first and second groups.

### CROSS-REFERENCE TO RELATED APPLICATIONS

This application claims priority to and the benefit of Taiwanese Patent Application No. 112208427, filed on Aug. 9, 2023. This application also claims priority to and the benefit of Taiwanese Patent Application No. 112205582, filed on Jun. 2, 2023. This application also claims priority to and the benefit of Taiwanese Patent Application No. 112205581, filed on Jun. 2, 2023. This application also claims priority to and the benefit of Taiwanese Patent Application No. 112205580, filed on Jun. 2, 2023. The contents of these applications are incorporated herein by reference in their entirety.

### FIELD

This application relates generally to interconnection systems, such as those including electrical connectors, used to interconnect electronic assemblies.

### BACKGROUND

Electrical connectors are used in many electronic systems. In general, many types of electronic devices (e.g., smart phones, tablet computers, desktop computers, notebook computers, and digital cameras, and the like) have been provided with various types of electrical connectors such that the electronic devices can exchange electrical power and electrical signals with each other. Electrical connectors can be used for communication between devices, between electrical components within a device, and between electrical systems comprised of, e.g., one or more electrical devices.

Generally, a plug connector and a receptacle connector may be configured to mate with each other. The receptacle connector is sometimes referred to as a socket connector in that it may comprise one or more concave sockets or recesses for accommodating corresponding one or more convex protrusions of the plug connector. A recess of the receptacle connector may accommodate one or more sets of conductive elements for enabling transmission of electrical power and/or electrical signals. The one or more convex protrusions of the plug connector may comprise one or more circuit boards with conductive pads or strips, and/or conductive pins, and/or other conductive structures configured to contact the conductive elements of the receptacle connector when the plug connector is mated with the receptacle connector. For example, the plug connector may comprise a protruding tongue comprising conductive strips leading to cable.

When a receptacle connector is configured for a plurality of transmission purposes (e.g., high-power transmission, lower-power transmission, signal transmission of a first transmission protocol, signal transmission of second protocol, etc.) terminal assemblies having different specifications may be provided inside the one or more recesses. In such cases, if adjacent terminal assemblies having different specifications are too close to each other, electromagnetic interference (EMI) may be generated, which may lead to a reduced signal-transmission quality. To reduce the amount of undesirable EMI, a partition wall may be provided between the adjacent terminal assemblies.

One technique that has been used to facilitate mating of the plug and receptacle connectors is to provide the one or more protrusions of the plug connector with grooves. For example, a plug connector may comprise a tongue with at least one groove formed therein such that, when the plug connector is being plugged into a receptacle connector, a partition wall of the receptacle connector may be inserted into the groove and move smoothly relative to the groove. This may help ensure that the mating is performed correctly.

It is generally easier and more cost-effective to manufacture a system as separate electronic assemblies, such as separate printed circuit boards (“PCBs”), which may be joined together with electrical connectors. In some scenarios, the PCBs to be joined together may have electrical connectors mounted to them, which may be mated to interconnect the PCBs. In other scenarios, the PCBs may be connected via a cable. Electrical connectors may nonetheless be used to make such connections. For example, the cable may be terminated at one or both ends with a plug connector. A PCB may be equipped with a receptacle connector into which the plug connector is inserted, to make an electrical connection between the PCB and the cable. A similar arrangement may be used at the other end of the cable, to connect the cable to another PCB, such that signals may pass between the PCBs through the cable.

One type of cable that may be used to connect two electronic apparatuses is an active cable, which may refer to a cable comprising electronic components along a length of cable of the cable. In some cases, the electronic components along the length of the cable of the cable may comprise any combination of a microcontroller, an adapter, an amplifier, and the like. The electronic components may be configured to process electrical signals (e.g., power and/or data) transmitted via the cable, to optimize performance and/or to optimize reliability of data transmissions.

### SUMMARY

Aspects of the present disclosure relate to robust connectors and active cables therewith.

Some embodiments relate to an electrical connector. The electrical connector may include a housing comprising a slot elongated in a horizontal direction; a first terminal assembly disposed in the housing, the first terminal assembly comprising a plurality of first conductive elements, each of the plurality of first conductive elements comprising a mating portion in the slot, a tail portion extending out of the housing, and an intermediate portion between the mating portion and the tail portion; and a second terminal assembly disposed in the housing and aligned with and spaced from the first terminal assembly in the horizontal direction, the second terminal assembly comprising a plurality of second conductive elements, each of the plurality of second conductive elements comprising a mating portion in the slot, a tail portion extending out of the housing, and an intermediate portion between the mating portion and the tail portion.

Optionally, the first terminal assembly conforms to a first interface standard; and the second terminal assembly conforms to a second interface standard different from the first interface standard.

Optionally, the second terminal assembly is spaced from the first terminal assembly in the horizontal direction by a center-to-center distance; and the center-to-center distance is greater than both a center-to-center pitch between adjacent first conductive elements and a center-to-center pitch between adjacent second conductive elements.

Optionally, the center-to-center distance is no less than 4.13 mm.

Optionally, the first terminal assembly comprises a first number of first conductive elements; and the second terminal assembly comprises a second number of second conductive elements different from the first number.

Optionally, the first number is 37; and the second number is in the range of 1 to 3.

Optionally, the first terminal assembly comprises an assembly housing holding the plurality of first terminals; the assembly housing of the first terminal assembly is disposed in the housing of the electrical connector; and the plurality of second terminals of the second terminal assembly are directly disposed in the housing of the electrical connector.

Optionally, at least a part of the intermediate portion of each second conductive element of the second terminal assembly is disposed closer to a long side wall of the housing than a corresponding part of the intermediate portion of each first conductive element of the first terminal assembly.

Optionally, the first terminal assembly is a first first terminal assembly disposed on a first side of the slot; the second terminal assembly is a first second terminal assembly disposed on the first side of the slot; and the electrical connector comprises a second first terminal assembly disposed on a second side of the slot opposite the first side, and a second second terminal assembly disposed on the second side of the slot and aligned with and spaced from the second first terminal assembly in the horizontal direction.

Optionally, the first and second first terminal assemblies are disposed in a first portion of the housing having a first width in a transverse direction perpendicular to the horizontal direction; the first and second second terminal assemblies are disposed in a second portion of the housing having a second width in the transverse direction; and a third portion of the housing has a third width in the transverse direction greater than both the first width and the second width.

Some embodiments relate to a circuit board for an electrical connector. The circuit board may include a first group of conductive pads aligned in a horizontal direction; a second group of conductive pads aligned with and spaced from the first group of conductive pads in the horizontal direction; and a third group of conductive pads electrically coupled to respective conductive pads in the first and second groups.

Optionally, the second group of conductive pads is spaced from the first group of conductive pads in the horizontal direction by a first distance; and a combined length of the first and second groups of conductive pads and the first distance is greater than a length of the third group of conductive pads in the horizontal direction.

Optionally, the third group of conductive pads is spaced from the first group of conductive pads in a transverse direction perpendicular to the horizontal direction by a second distance and spaced from the second group of conductive pads in the transverse direction by the second distance.

Optionally, the first group of conductive pads comprises a first number of conductive pads; and the second group of conductive pads comprises a second number of conductive pads in a range of 1 to 3.

Optionally, the first number is 37; and the third group of conductive pads comprise a third number of conductive pads in a range of 38 to 40.

Some embodiments relate to a cable assembly. The cable assembly may include a circuit board described herein; and a cable comprising a plurality of wires each attached to a respective one of the third group of conductive pads.

Some embodiments relate to an active cable. The active cable may include a cable comprising a plurality of wires extending from a first end to a second end; a first circuit board disposed at the first end of the cable, the first circuit board comprising a first group of contact pads aligned in a first row, a second group of contact pads aligned in the first row with the first group of contact pads and separated from the first group of contact pads by a space, and a third group of contact pads disposed in a second row physically connected to the plurality of wires; and a second circuit board disposed at the second end of the cable, the second circuit board comprising a control chip and a plurality of contact pads electrically coupled to the control chip and physically connected to the plurality of wires.

Optionally, the first circuit board extends in parallel to the second circuit board.

Optionally, the first circuit board extends in orthogonal to the second circuit board.

Optionally, for the first circuit board, the second row extends in orthogonal to the first row.

These techniques may be used alone or in any suitable combination. The foregoing is a non-limiting summary of the application, which is defined by the attached claims.

### BRIEF DESCRIPTION OF DRAWINGS

A skilled artisan will understand that the figures, described herein, are for illustration purposes only. It is to be understood that in some instances various aspects of the present disclosure may be shown exaggerated or enlarged to facilitate an understanding of the disclosure. In the drawings, like reference characters generally refer to like features, which may be functionally similar and/or structurally similar elements, throughout the various figures. The drawings are not necessarily to scale, as emphasis is instead placed on illustrating and teaching principles of the various aspects of the disclosure. The drawings are not intended to limit the scope of the present teachings in any way.

FIG. 1A shows a top, front perspective view of an electrical connector, according to some embodiments.

FIG. 1B shows a partially exploded top, front perspective view of the connector of FIG. 1A, according to some embodiments.

FIGS. 1C through 1H show a front view, a rear view, a left side view, a right side view, a top view, and a bottom view, respectively, of the connector of FIG. 1A, according to some embodiments.

FIG. 2A shows a top, front perspective view of the electrical connector of FIG. 1A, according to some embodiments.

FIG. 2B shows another top front perspective view of the electrical connector of FIG. 2A, according to some embodiments.

FIG. 3 shows a cross-sectional perspective view of the connector of FIG. 1A along a line marked “3-3” in FIG. 1A, according to some embodiments.

FIG. 4A shows a top view of the electrical connector of FIG. 1A, according to some embodiments.

FIG. 4B shows another top view of the electrical connector of FIG. 1A, according to some embodiments.

FIGS. 5A and 5B shows a left side view and a right side view, respectively, of the electrical connector of FIG. 1A, with a shell and housing hidden, showing a first terminal assembly and a second terminal assembly, according to some embodiments.

FIG. 6 shows a front view of the first terminal assembly and the second terminal assembly of FIG. 5A, according to some embodiments.

FIG. 7 shows a top view of an electrical connector, according to some embodiments.

FIG. 8A shows a top, front perspective view of a receptacle connector and a plug connector positioned to mate with the receptacle connector, according to some embodiments.

FIG. 8B shows a front view of the receptacle connector and the plug connector of FIG. 8A, according to some embodiments.

FIGS. 9A and 9B show a front view and a top, front perspective view of a plug connector, according to some embodiments.

FIGS. 9C and 9D show a bottom view and a bottom, front perspective view of the plug connector of FIG. 9A, according to some embodiments.

FIG. 10A shows a top view of a portion of an active cable with an electrical connector attached to an end thereof, according to some embodiments.

FIG. 10B shows a top, side perspective view of a portion of an active cable with an electrical connector attached to an end thereof, according to some embodiments.

FIG. 10C shows a top, side perspective view of a portion of an active cable with an electrical connector attached to an end thereof, according to some embodiments.

FIG. 11A shows a top, front perspective view of an active cable, with first and second electrical connectors attached to front and rear ends, respectively, according to some embodiments.

FIG. 11B shows a top, rear perspective view of the active cable attached with the first and second electrical connectors, according to some embodiments.

FIG. 12A shows a partially exploded perspective view of a portion of the active cable of FIG. 11A, showing the first connector and active circuitry, according to some embodiments.

FIG. 12B shows a partially exploded perspective view of the active cable of FIG. 11A, showing the second connector exploded, according to some embodiments.

FIG. 12C shows a bottom perspective view of the active cable of FIG. 11B, showing the second connector exploded, according to some embodiments.

FIG. 12D shows a perspective view of the active cable of FIG. 11B, showing the second connector exploded, according to some embodiments.

FIG. 13A shows a plan view of a circuit board of a connector, according to some embodiments.

FIG. 13B shows a plan view of a circuit board of a connector, according to some embodiments.

FIGS. 14A and 14B show top and bottom perspective views, respectively, of an active cable, according to some embodiments.

The following reference numbers are used in the drawings:
g1 edge-to-edge pitch
G1 center-to-center pitch
G2 pitch
h1 edge-to-edge pitch
h2 edge-to-edge pitch
H1 center-to-center pitch
H2 center-to-center pitch
L uniform separation distance
L1 separation distance
L2 separation distance
L3 separation distance
M mating direction
Z3 vertical plane
1 plug connector
1a plug connector
1b plug connector
10a first housing
100 electrical connector
100′ electrical connector
11 housing
11a first housing
110 slot
111 long side of slot
111a shelf
112 short side of slot
12 plug circuit board
12a first circuit board
12e insertion edge
12A first plug board
12B second plug board
12C alignment protrusion
13 first terminal assembly
131 first terminal
1311 mating portion
1312 intermediate portion
1313 tail portion
133 first terminal assembly housing
14 first plug terminal assembly
141 first plug terminal
15 second terminal assembly
151 second terminal
1511 mating portion
1512 intermediate portion
1513 tail portion
16 second plug terminal assembly
161 second plug terminal
17 shell
170 space
171 sub-space
2 plug connector
21 second housing
22 second circuit board
23 second housing
25 third plug terminal assembly
251 third plug terminal
26 fourth plug terminal assembly
262 fourth plug terminal
3 active circuitry
31 control chip
32 circuit board
33 shell
331 first shell portion
332 second shell portion
4 cable
5 plug connector
6 receptacle connector
7 substrate

### DETAILED DESCRIPTION

The inventors have recognized and appreciated design techniques for making electrical interconnection systems both suitable for deployment in small spaces and capable of providing high-quality transmissions. Cables often are manufactured with desirable electrical properties to pass signals between electrical devices, components, and/or systems. These desirable electrical properties may include low attenuation and uniform impedance. It is often desired to maintain these desirable electrical properties through mated plug and receptacle connectors, such that a signal may travel a complete path between interconnected PCBs without significant impact on signal integrity. It is a challenge, however, to design a connector that provides these desirable electrical properties while meeting other requirements, such as to occupy a small volume of space and/or to provide reliable operation.

Furthermore, there have been an increasing demand for thinner, smaller, and lighter electronic apparatuses in recent years, resulting in an increased need for connectors of sufficient thinness, smallness, and lightness to be use within such apparatuses. However, as connectors become thinner and thinner there may be an associated decrease in robustness of the connectors. Delicate connectors may not hold up to repeated matings and unmatings and/or may not hold up to an amount of mating force typically required to push together a pair of plug and receptacle connectors, and may suffer premature breakage, which may lead to unwanted transmission interruptions. It should be appreciated that transmission interruptions are unacceptable for normal operation of electronic apparatuses. Moreover, the added costs of troubleshooting, maintenance, and/or replacement of faulty connectors further degrades user experience and, in some cases, the downtime of electronic apparatuses may result in business losses for when the electronic apparatus are used to support business operations.

According to aspects of the present disclosure, electrical connectors can have a robust and compact structure and that have a reduced amount of electrical noise. According to aspects of the present disclosure, an active cable can be used to connect such electrical connectors and comprise circuitry configured to process transmitted signals/power to enhance transmission quality and/or to change one or more characteristics of the transmitted signals/power.

In some embodiments, an electrical connector may comprise a plurality of different types of terminal assemblies configured to transmit a plurality of different types of electrical signals (e.g., high power, low power, data, ground, first signal type, second signal type, etc.). The terminal assemblies may be arranged in the connector such that EMI is reduced. In some embodiments, the connector may comprise structural components configured to increase the connector's robustness against fatigue and/or fracture due to repeated mating and unmating operations, without appreciably increasing the connector's size.

In some embodiments, the connector may be configured such that improper mating, which may cause damage to the connector due to an associate improper application of a mating force, may be avoided. In some embodiments, the connector may be configured such that a user may perform a mating operation for example, without seeing the connector during the mating operation. For example, for small-sized connectors that may be located in a tight space where the connectors may be easily viewed, a user may perform a blind mating operation of a plug connector to a receptacle connector, even though the user may not be able to see a relative position between these connector during the mating operation, the user may understand the relative position through asymmetrical protrusions and/or other identifying structures, thus facilitating proper alignment of these connectors by the user prior to application of a mating force to push these connectors together.

In some embodiments, an active cable may comprise a transmission line, a first connector attached to a first end of the transmission line, a second connector attached to a second end of the transmission line, and active circuitry disposed along a length of the transmission line and configured to process electrical signals between the first and second connectors. In some embodiments, the first connector and/or the second connector may be an electrical connector according to any of the embodiments of connectors disclosed herein and may comprise multiple terminal assemblies.

In some embodiments, the active circuitry may comprise at least one PCB comprising a controller and signal-processing circuits. The controller may control transmission of one or more signals through one or more of the signal-processing circuits, which may perform desired conditioning of the one or more signals, and may output one or more conditioned signals. In some embodiments, the active circuitry may comprise a plurality of PCBs. In some embodiments, the signals may be selectively modified before reaching a destination connector. In some embodiments, the signals may be selectively delayed during transmission. It should be appreciated that signals may be transmitted from the first connector to the second connector or from the second connector to the first connector; therefore, the destination connector may be the first connector or the second connector.

In some embodiments, the at least one PCB may comprise a relay PCB. The relay PCB may comprise a relay controller and relay circuits disposed on a substrate and configured to control movement of signals to the destination connector. For example, the relay circuits may be controlled by the relay controller to change a propagation distance of one or more signals, to facilitate a timing of the one or more signals by shortening or lengthening the propagation distance. In some embodiments, the relay controller may comprise at least one relay control chip supported by the substrate and operably connected to the transmission line and the relay circuits. In some embodiments, the relay circuits may be operably connected to the transmission line.

In some embodiments, the circuitry of the cable may comprise a first PCB connected to the first connector and a second PCB connected to the connector. The first circuit board may be provided with a plurality of conductive terminals. For example, the first circuit board may be provided with a set of first conductive terminals and a set of second conductive terminals. The set of first conductive terminals may comprise a plurality of first conductive pads or strips. The set of second conductive terminals may comprise at least one second conductive pad or strip. In some embodiments, a first conductive pad or strip may be separated from a second conductive pad or strip by at least a first separation distance.

The inventors have recognized and appreciated that, by using a PCB in which one or more control chips (e.g., relay control chips) and one or more circuits (e.g., relay circuits, signal-processing circuits, etc.) are integrated on a single substrate, it may be possible to facilitate circuit adjustment and layout optimization of circuit elements by increasing design flexibility. The inventors also have recognized and appreciated that an ability to change propagation distance can prevent or minimize external interference and, consequently, improve transmission efficiency and signal quality. The inventors have further recognized and appreciated that by providing the first connector with multiple terminal assemblies, the active cable may be connected to various electronic devices and electrical hardware components while conserving space, thus enabling an electrical apparatus in which the cable is deployed to be compact. Disclosed herein is an electrical connector that includes a plurality of terminal assemblies, and an active cable comprising an electrical connector that includes a plurality of types of terminal assemblies. Crosstalk and/or other types of interference may be minimized or avoided by provide a predetermined distance between adjacent terminal assemblies.

More specifically, the present technology relates to an electrical connector and an active cable for the connector, in which the connector includes multiple terminal assemblies spaced from each other at a predetermined distance, and in which the cable includes active circuitry disposed along cable of the cable. The predetermined distance between terminal assemblies of the connector may be 4.13 millimeters (mm) or greater. The active circuitry of the cable may include a circuit board provided with at least one control chip configured to change one or more characteristics of signals and/or power transmitted via the cable.

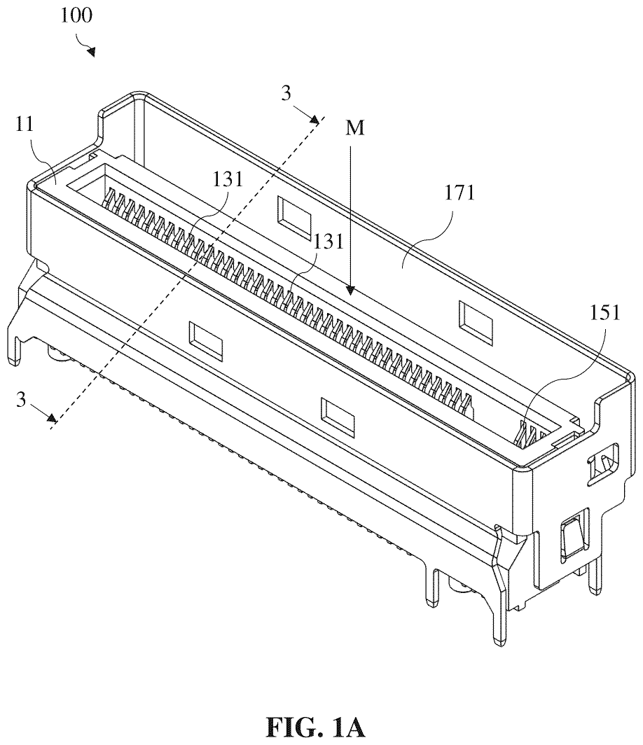

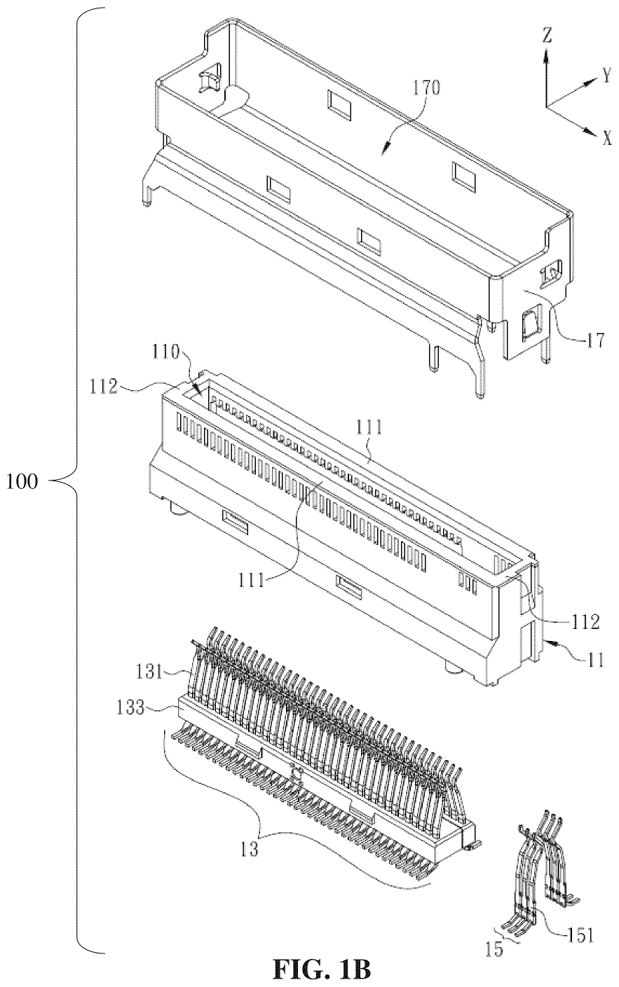

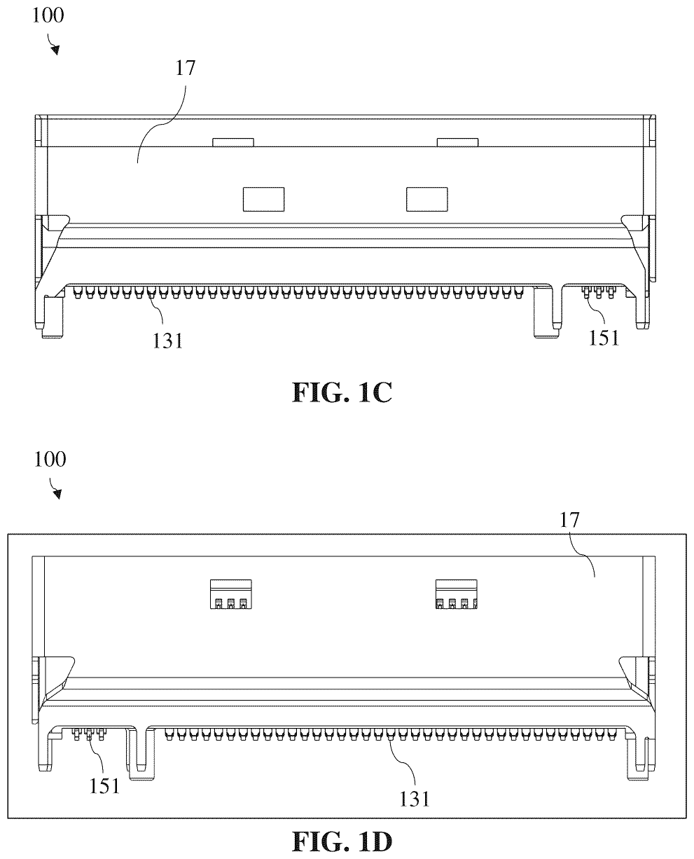

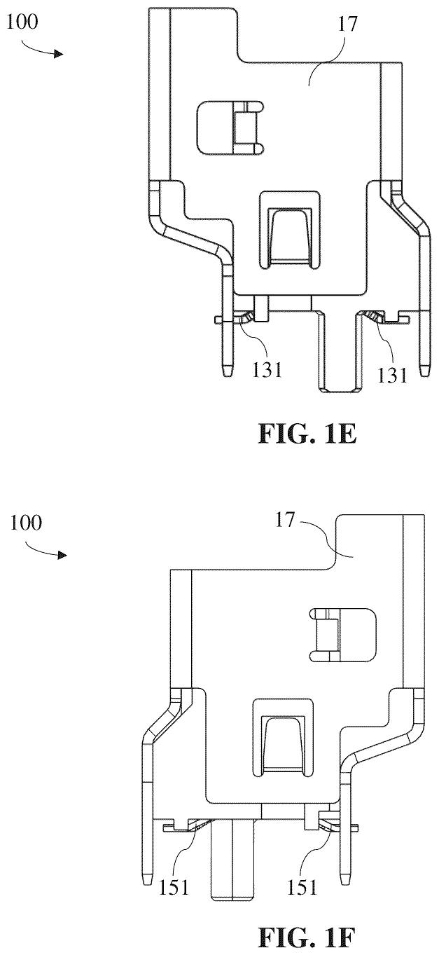

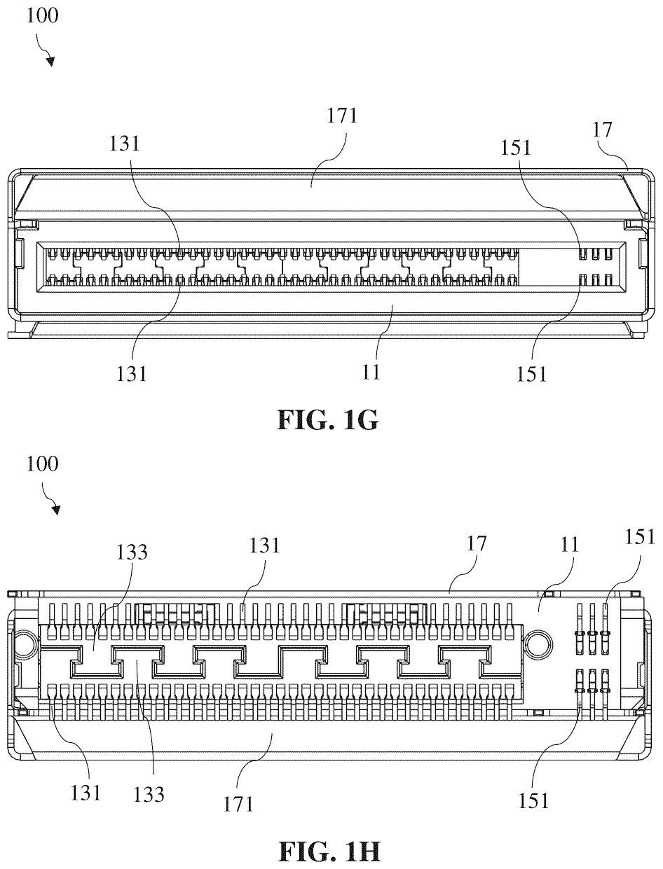

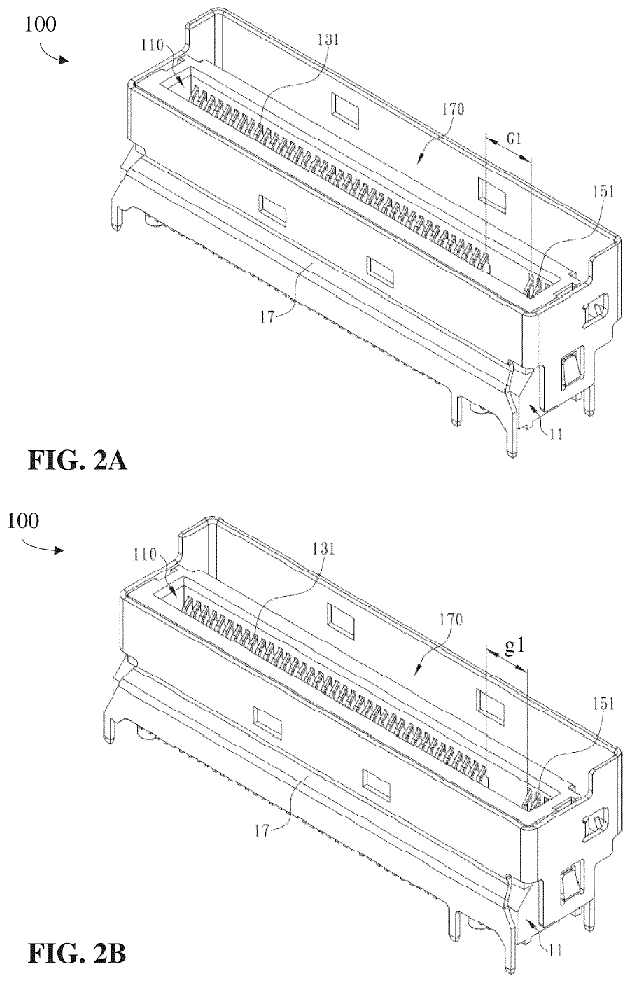

Turning now to the drawings, FIG. 1A shows a top front perspective view of an electrical connector 100, according to some embodiments. FIG. 1B shows a top front perspective view of the connector 100 in a partially disassembled state. FIGS. 1C through 1H show a front view, a rear view, a left side view, a right side view, a top view, and a bottom view, respectively, of the connector 100.

According to some embodiments, the electrical connector 100 may comprise a housing 11, at least one first terminal assembly 13 disposed in the housing 11, at least one second terminal assembly 15 disposed in the housing 11, and a shell 17 encircling a periphery of the housing 11. For the convenience of description, directions and orientations with respect to the connector 100 may be described relative to three mutually orthogonal axes, shown in FIG. 1B, including an X axis corresponding to a horizontal direction, a Y axis corresponding to a longitudinal direction, and a Z axis corresponding to a vertical direction. In some embodiments, the connector 100 may be elongated in the horizontal direction, which may correspond to a left-right direction of the connector 100, the transverse direction may correspond to a front-rear direction of the connector 100, and the vertical direction may correspond to a top-bottom (or upper-lower) direction of the connector 100.

According to some embodiments, the housing 11 may be provided with a slot 110, which may be a recess configured to receive a corresponding protrusion of a mating connector when the electrical connector 100 and the mating connector are in a mated state. In some embodiments, the slot 110 may extend inwardly from a top surface of the housing 11 toward a bottom side of the housing 11. In some embodiments, a mating direction of the mating connector relative to the connector 100 may be in the vertical direction represented by an arrow M in FIG. 1A. The slot 110 may comprise a single opening or a plurality of openings configured to receive therein corresponding portions of the mating connector. In some embodiments, the plurality of openings may be discrete spaces, e.g., spaces that are physically separate from each other, or the plurality of openings may be in communication with each, e.g., spaces that are joined together by one or more common openings (e.g., one or more conduits).

According to some embodiments, the electrical connector 100 may be a receptacle connector configured to receive a tongue protruding from a plug connector. In some embodiments, the tongue of the plug connector may be a PCB comprising conductive terminal pads configured to contact conductive first terminals 131 of the first terminal assembly 13 and conductive second terminals 151 of the second terminal assembly 15 when the plug connector is mated with the receptacle connector. The first and second terminals 131, 151 may be formed of metal. In some embodiments where the slot 110 comprises a plurality of openings, the tongue may comprise a plurality of mating portions configured to be received in corresponding ones of the plurality of openings of the slot 110. For example, the mating portions may comprise insertion edges that are physically separate from each other, and may comprise base edges that are contiguous with each other. In some embodiments, the tongue may comprise a mating portion formed of a conductive plate. In some embodiments, during a mating operation, the tongue of the plug connector may move in the vertical direction into the slot 110.

It should be understood that although the slot 110 is shown in FIG. 1A to be open at the top surface of the electrical connector 100, in some embodiments the slot 110 may be open at a bottom surface of the connector 100 and may extend inwardly toward a top side of the connector 100.

According to some embodiments, the slot 110 of the housing 11 may be bounded by two long sides 111 and two short sides 112. The long sides 111 may be on opposite sides of the slot 110. The short sides may be on opposite sides of the slot 110. In some embodiments, inner walls of the long sides 111 may face each other and may comprise portions that have substantially flat surfaces. In some embodiments, the flat surfaces of the inner walls of the long sides 111 may be devoid of protruding structures but may include holes or recesses. In some embodiments, the holes or recesses in the inner walls of the long sides 111 may be configured to receive portions of the first and second terminals 131, 151. For example, the holes or recesses may be configured to receive top ends of the first and second terminals 131, 151. In some embodiments, an upper edge of the slot 110 may be beveled to guide the protruding portion of the mating connector during a mating operation. For example, top edges of the long sides 111 and top edges of the short sides 112 may have inclined surfaces for facilitating insertion of a tongue of a plug connector.

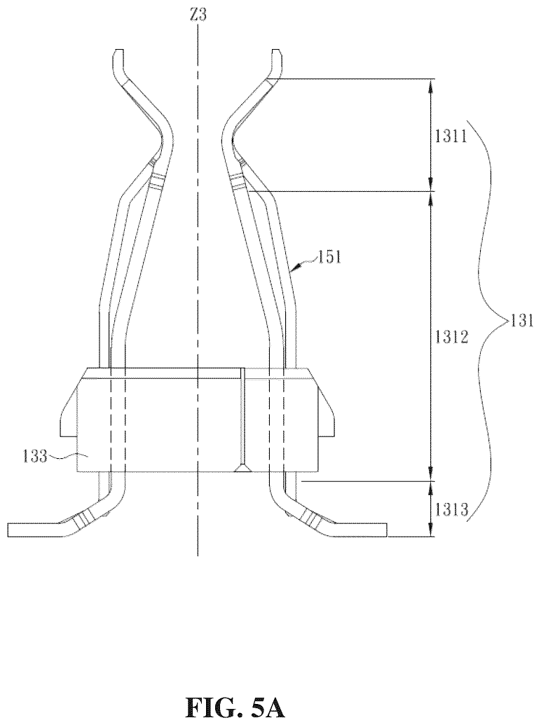

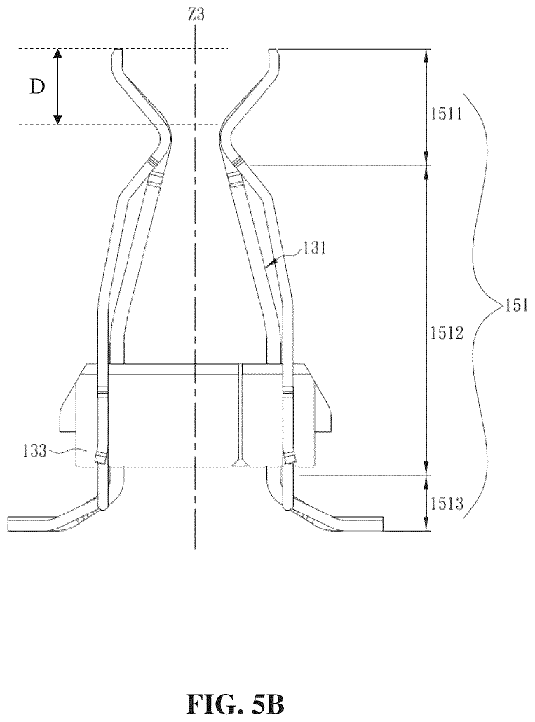

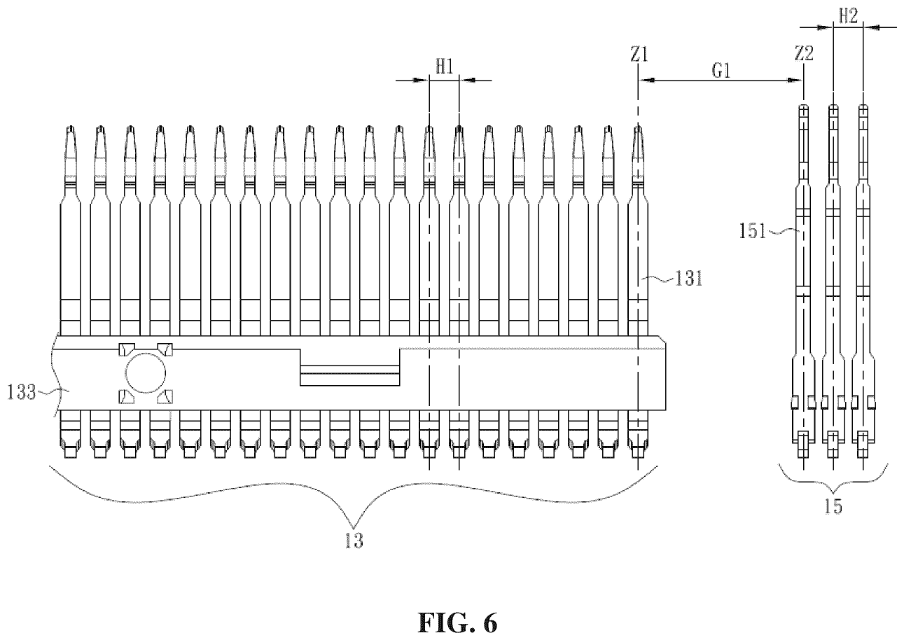

FIGS. 5A, 5B, and 6 show a left side view, a right side view, and a front view, respectively, of the first terminal assembly 13 and the second terminal assembly 15 as they would be positioned in the slot 110 of the electrical connector 100, according to some embodiments. FIGS. 5A, 5B, and 6 show the electrical connector 100 without the shell 17 and without the housing 11.

According to some embodiments, each first terminal 131 may be formed of metal and may comprise a mating portion 1311, a tail portion 1313, and an intermediate portion 1312 connecting the mating portion 1311 to the tail portion 1313. The mating portion 1311 may be configured to contact a corresponding mating portion of the mating connector to form an electrically conductive path between the first terminal 131 and the mating connector. The tail portion 1313 may be configured to be mounted to a circuit board and/or to electrical wiring to transmit electrical signals to the circuit board and/or to the wiring. For example, the tail portion 1313 may have a foot configured to be welded or soldered, or otherwise fused to an electrical contact pad on the circuit board. In another example, the tail portion 1313 may be configured to be soldered to a transmission wire of a multi-wire cable.

According to some embodiments, the first terminal assembly 13 may be disposed in the housing 11 such that at least a portion of the mating portion 1311 of each of the first terminals 131 is exposed in the slot 110. In some embodiments, the exposed portions of the mating portions 1311 may be visible to a user looking into the slot 110. In some embodiments, free ends of the first terminals 131 may be disposed respectively in the holes or recesses in the inner walls of the long sides 111 of the housing 11, as discussed above. In some embodiments, the first terminal assembly 13 may comprise a total of 74 first terminals 131 arranged in two parallel rows. The two parallel rows may be oriented horizontally, e.g., parallel to the X axis (see FIG. 1B). In some embodiments, the first terminals 131 may be arranged symmetrically in the two parallel rows of 37 first terminals 131 per row and may be configured to contact opposite sides of the protrusion of the mating connector, when the mating connector is mated with the electrical connector 100. In some embodiments, the first terminals 131 may be arranged asymmetrically. For example, the two parallel rows may comprise different numbers of the first terminals 131. In some embodiments, the first terminals 131 may be arranged in a single row and may be configured to contact a single side of the protrusion of the mating connector, when the mating connector is mated with the connector 100.

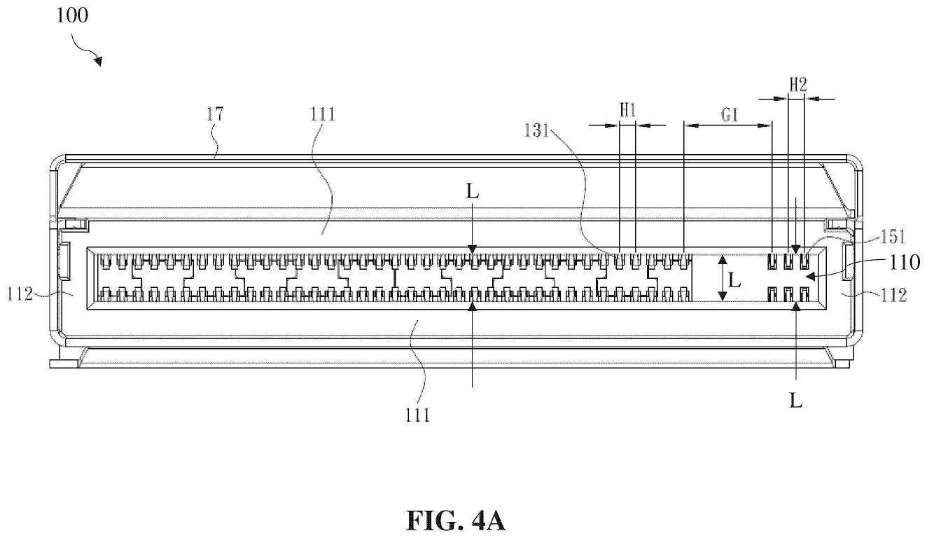

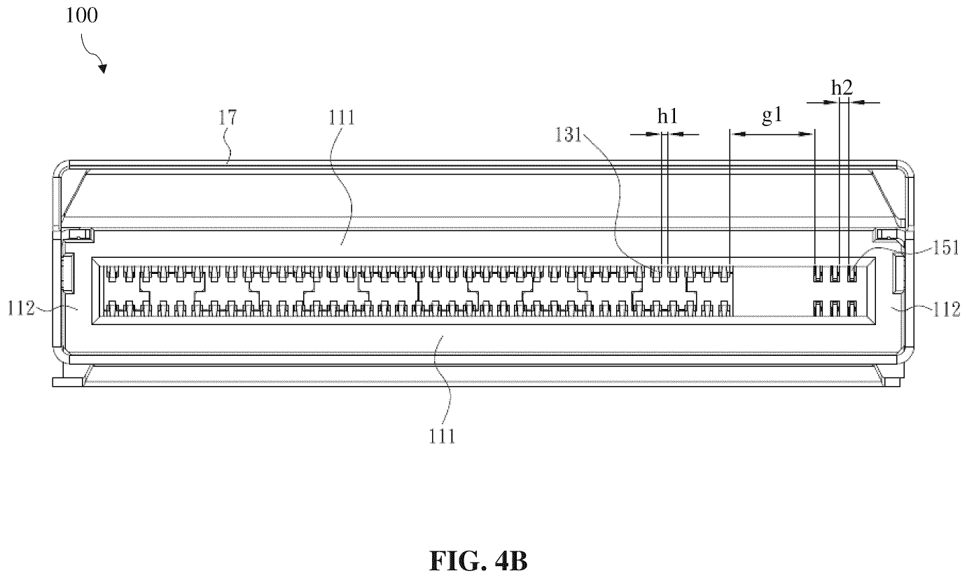

According to some embodiments, the first terminal assembly 13 may conform to specifications of a first interface standard. In some embodiments, the first terminals 131 of the first terminal assembly 13 may be aligned in two horizontal rows that face each other, as shown in FIG. 1G. In some embodiments, adjacent first terminals 131 may be separated from each other by a center-to-center pitch H1, as shown in FIG. 4A. In some embodiments, adjacent first terminals 131 may be separated from each other by an edge-to-edge pitch h1, which may be a spacing of nearest edges of the adjacent first terminals, as shown in FIG. 4B. For example, for an adjacent pair of first terminals 131, a right edge of the first terminal 131 on the left may be separated from a left edge of the first terminal 131 on the right by the edge-to-edge pitch h1.

According to some embodiments, each second terminal 151 may comprise a mating portion 1511, a tail portion 1513, and an intermediate portion 1512 connecting the mating portion 1511 to the tail portion 1513. The mating portion 1511 may be configured to contact a corresponding mating portion of the mating connector to form an electrically conductive path between the second terminal 151 and the mating connector. The tail portion 1513 may be configured to be mounted to a circuit board and/or to electrical wiring to transmit electrical signals to the circuit board and/or to the wiring. The circuit board on which the second terminals 151 are mounted may be the same circuit board as that on which the first terminals 131 are mounted.

According to some embodiments, the second terminal assembly 15 may be disposed in the housing 11 such that at least a portion of the mating portion 1511 of each of the second terminals 151 is exposed in the slot 110. In some embodiments, the exposed portions of the mating portions 1511 may be visible to a user looking into the slot 110. In some embodiments, free ends of the second terminals 151 may be disposed respectively in the holes or recesses in the inner walls of the long sides 111 of the housing 11, as discussed above. In some embodiments, the second terminal assembly 15 may comprise a total number in a range of 2 to 6 second terminals 151 arranged in two parallel rows. The two parallel rows may be oriented horizontally, e.g., parallel to the X axis (see FIG. 1B). In some embodiments, the second terminals 151 may be arranged symmetrically in the two parallel rows and may be configured to contact opposite sides of the protrusion of the mating connector, when the mating connector is mated with the electrical connector 100. In some other embodiments, the second terminals 151 may be arranged in a single row and may be configured to contact a single side of the protrusion of the mating connector, when the mating connector is mated with the connector 100.

According to some embodiments, the second terminal assembly 15 may conform to specifications of a second interface standard, which may be the same as or different from the first interface standard. In some embodiments, the second terminals 151 of the second terminal assembly 15 may be formed of metal and may be aligned in two horizontal rows that face each other, as shown in FIG. 1G. In some embodiments, adjacent second terminals 151 may be spaced apart from each other by a center-to-center pitch H2, as shown in FIG. 4A. In some embodiments, adjacent second terminals 151 may be spaced apart from each other by an edge-to-edge pitch h2, which may be a spacing of nearest edges of the adjacent second terminals, as shown in FIG. 4B. For example, for an adjacent pair comprising a left second terminal and a right second terminal, a right edge of the left second terminal may be separated from a left edge of the right second terminal by the edge-to-edge pitch h2.

According to some embodiments, a first terminal Z1 and a second terminal Z2 nearest the first terminal Z1 may be separated by a center-to-center pitch G1, as shown in FIGS. 4A and 6, and may be separated by an edge-to-edge pitch g1, as shown in FIG. 4B. Referring to FIG. 6, the first terminal Z1 and the second terminal Z2 may be elongated in the vertical direction, e.g., parallel to the Z axis, and may have vertical centerlines that are parallel to each other. In FIG. 6, the vertical centerlines are represented by broken vertical lines. In some embodiments, the center-to-center pitch G1 may be greater than the center-to-center pitch H1 between adjacent first terminals 131 and also may be greater than the center-to-center pitch H2 between adjacent second terminals 151. In some embodiments, the edge-to-edge pitch g1 may be greater than the edge-to-edge pitch h1 between adjacent first terminals 131 and also may be greater than the edge-to-edge pitch H2 between adjacent second terminals 151. In some embodiments, the center-to-center pitch G1 may be 4.13 mm or greater, which may be effective to avoid or reduce mutual interference between the first terminal assembly 13 and the second terminal assembly 15 during transmission of signals. In some embodiments, the edge-to-edge pitch g1 may be 4.13 mm or greater. In some embodiments, the slot 110 may be a continuous opening with no physical structure separating a region in which the first terminals 131 are exposed and a region in which the second terminals 151 are exposed. Such a continuous opening may enable the protrusion of the mating structure to comprise a single circuit board with conductive pads located along one or both sides of a single insertion edge and configured to contact the first terminals 131 and the second terminals 151, or to comprise multiple circuit boards with multiple insertion edges, with contact pads located along one or both sides of the multiple insertion edges. As noted above, the multiple circuit boards may be physically spaced apart from each other at the insertion edges may be joined to each other at a common base. The multiple circuit boards may be smoothly inserted in the slot 110 together, e.g., in a single mating operation, which may facilitate mating of the electrical connector 100 with the mating connector. In some embodiments, the center-to-center pitch G1 of the edge-to-edge pitch g1 may be a predetermined distance that minimizes or eliminates EMI between the first terminals 131 and the second terminals 151.

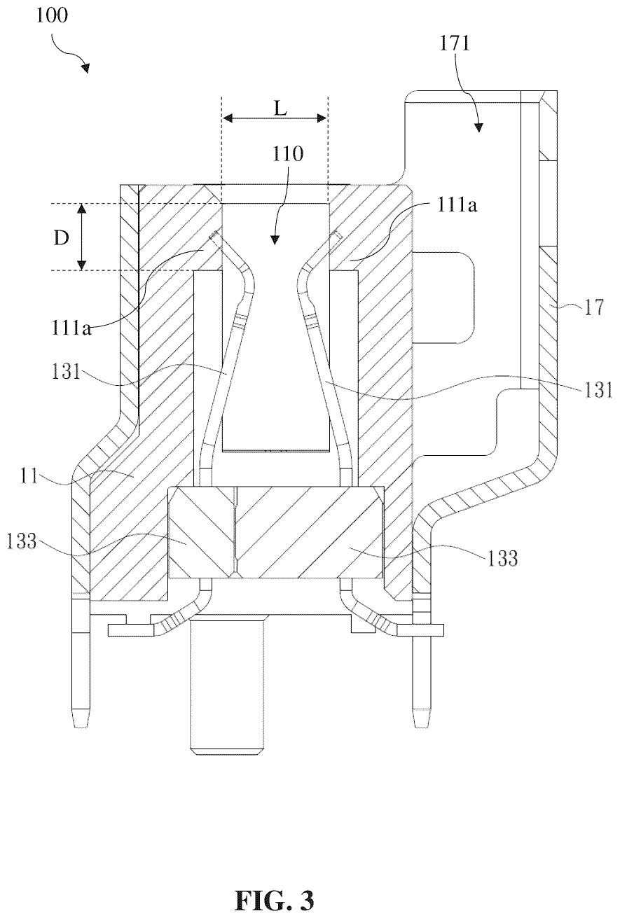

According to some embodiments, the inner walls of the two long sides 111 of the housing 11 may have a uniform separation distance L along a length of the slot 110, as shown in FIG. 4A. Portions of the slot 110 corresponding to the first terminal assembly 13, the second terminal assembly 15, and a region separating the first terminal assembly 13 from the second terminal assembly 15 may have the same transverse (Y-direction) spacing. In some embodiments, an upper region of each of the two long sides 111 of the housing 11 may comprise a shelf 111a having a vertical height D, as shown in FIG. 3. In some embodiments, inner surfaces of the two shelves 111a may be devoid of any protrusion that would reduce the uniform separation distance L and therefore the uniform separation distance L may be a minimum separation distance L of the slot 110. In some embodiments, the holes or recesses in the inner walls of the long sides 111 of the housing 11, discussed above, may be holes or recesses in the inner surfaces of the shelves 11a, which may be configured to receive free ends of the mating portions 1311, 1511 of the first and second terminals 131, 151, as depicted in FIG. 3.

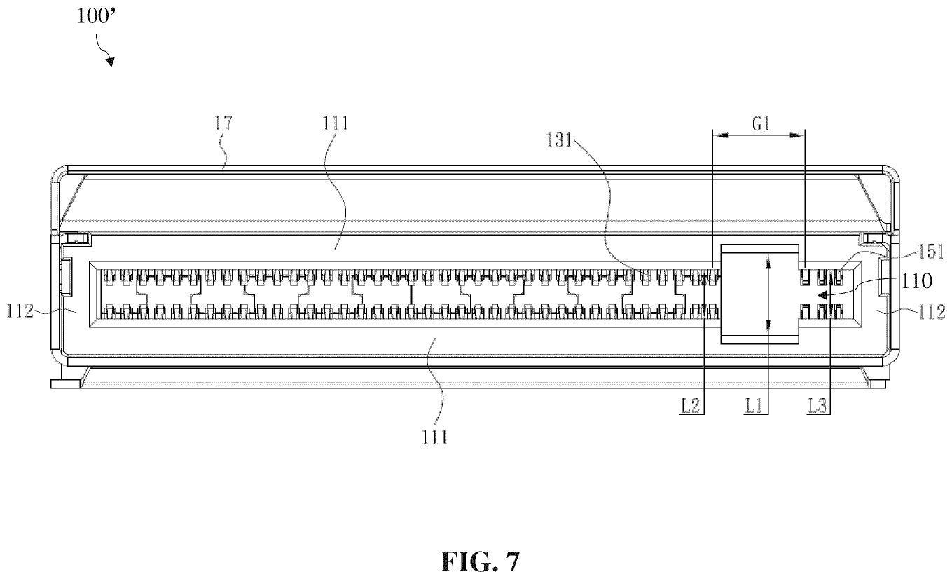

FIG. 7 shows a top view of an electrical connector 100′, according to some embodiments. The connector 100′ may be similar in many respects to the electrical connector 100 and therefore differences between the connectors 100, 100′ will be described. In some embodiments, the inner walls of the two long sides 111 of the housing 11 of the connector 100′ may not have a uniform separation distance along the length of the slot 110. In some embodiments, the portion of the slot 110 corresponding to the region separating the first terminal assembly 13 from the second terminal assembly 15 may have a separation distance L1, the portion of the slot 110 corresponding to the first terminal assembly 13 may have a separation distance L2, and the portion of the slot 110 corresponding to the second terminal assembly 15 may have a separation distance L3, as shown in FIG. 7. In some embodiments, the separation distances L1, L2, L3 are different from each other, e.g., L1/L2+L3. In some embodiments, the separation distances L2 and L3 corresponding to the first terminal assembly 13 and the second terminal assembly 15, respectively, may be the same but may be different from the separation distance L1 corresponding to the region separating the first terminal assembly 13 from the second terminal assembly 15, e.g., L2=L3+L1. The different separation distances L1, L2, L3 may reduce the risk of erroneous mating of a mating connector with the connector 100′ by having a single front-back orientation. An error in identifying a front of the connector 100′ would not lead to a successful mating operation.

According to some embodiments, the first terminal assembly 13 and the second terminal assembly 15 may be assembled in the housing 11 in different ways. In some embodiments, the first terminals 131 may be attached to at least one insulative first terminal assembly housing 133, as shown in FIGS. 1B and 3. For example, the electrical connector 100, 100′ may comprise two rows of first terminals 131 held by respective first terminal assembly housings 133 configured to engaged with each other via a plurality of T-shaped slots and T-shaped protrusions, as shown in FIG. 1H. In some embodiments, the first terminals 131 may be molded in the first terminal assembly housing 133 at fixed positions by injection molding a polymeric material around a portion of each of the first terminal 131 and curing the polymeric material to fix the positions of the first terminals 131. After attachment to the first terminal assembly housing 133, the first terminal assembly 13 may be installed in the housing 11. In some embodiments, the second terminals 151 may be disposed directly to the housing 11 without use of an intermediary structure such as a terminal assembly housing (e.g., the first terminal assembly housing 133 used for the first terminal assembly 15. In some embodiments, the second terminals 151 may be inserted into respective recesses (not shown) in the housing 11, which may hold the second terminals in place. For example, the second terminals 151 may be held in place in the recesses via a friction. In some embodiments, the housing 11 may be formed by injection molding a polymeric material around a portion of each of the second terminals 151 and then cured. In some embodiments, the housing 11 may be formed by injection molding, and each of the second terminals 151 may then be set in place in the polymeric material before the polymeric material is cured. It should be appreciated that other techniques may be used to attach the second terminals 151 to the housing 11, including through use of an intermediary structure.

As noted above, the first and second terminal assemblies 13, 15 may be arranged in one or more rows in the housing 11. Each row may extend in a horizontal direction and, in the case of two or more rows, the rows may be spaced apart from each other transversely. In some embodiments, the electrical connector 100, 100′ two rows of first and second terminal assemblies 13, 15 arranged to face each in the slot 110. In some embodiments, each row may comprise at least one first terminal assembly 13 and at least one second terminal assembly 15.

Referring to the side views of FIGS. 5A and 5B, it can be seen that, when the first and second terminals 131, 151 are positioned in the slot 110 of the housing 11, the intermediate portions 1512 of the second terminals 151 may have a larger degree of bending than the intermediate portions 1312 of the first terminals 131 relative to a central vertical plane Z3 of the slot 110, according to some embodiments. The intermediate portions 1512 of the second terminals 151 may be bent to a more acute angle than the intermediate portions 1312 of the first terminals 131. In some embodiments, the mating portions 1511 of the second terminals 151 and the mating portions 1311 may have portions that substantially overlap.

Referring to FIGS. 1A and 1B, the housing 17 may be formed of metal and may be structured to have an space 170 in which the housing 11 may be disposed. In some embodiments, the housing 17 may completely encircle the housing 11, which may reduce the risk of EMI when the housing 17 is grounded or connected to earth. In some embodiments, the electrical connector 100, 100′ may not include the housing 17. Although the housing 17 is depicted to be generally rectangular in shape and to have four sides when seen from a top view (see FIG. 1G), the housing 17 may, in some embodiments, be non-rectangular and/or may be U-shaped (e.g., have three walls). In some embodiments, the housing 17 may be larger than the housing 11 such that a portion of the space 170 is not filled by the housing 11. For example, as shown in FIGS. 1A and 1G, an internal side of a rear wall of the housing 17 may be spaced from an external side of a rear wall of the housing 11 and may abound a sub-space 171 in the space 170. In some embodiments, the sub-space 171 may be configured to receiving a protrusion of the mating connector.

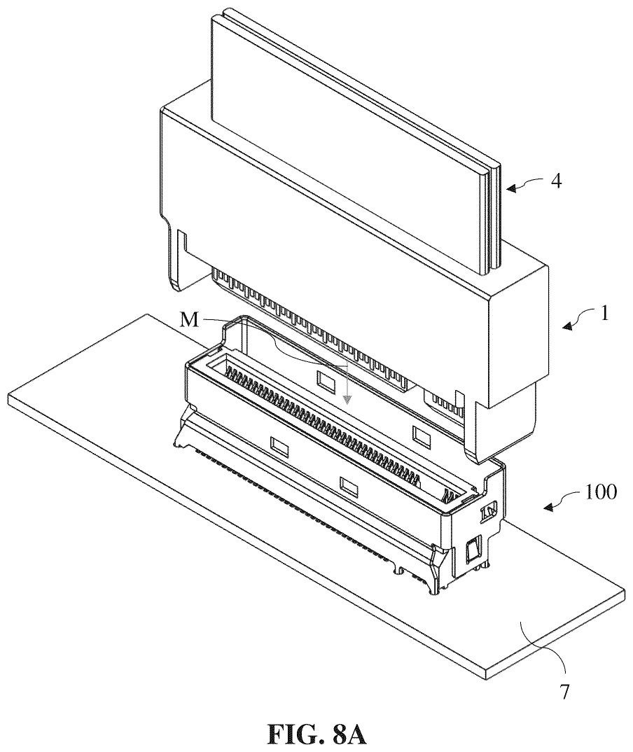

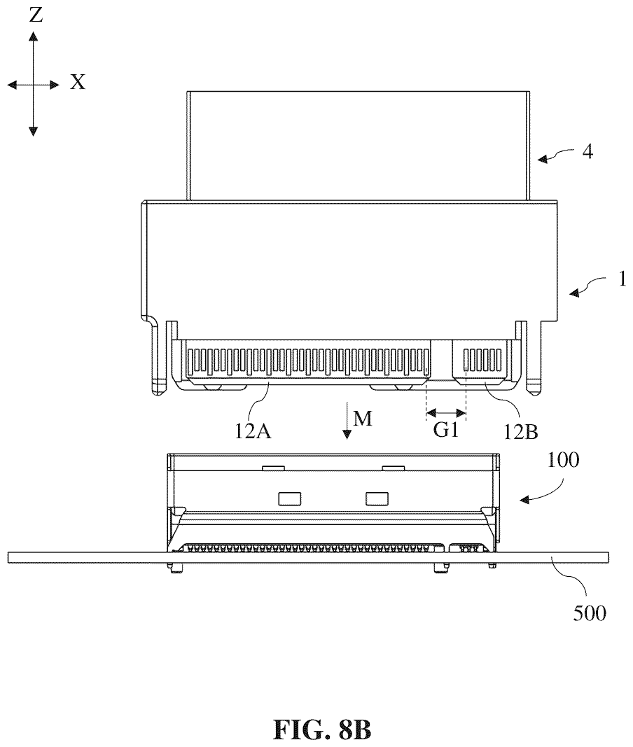

According to some embodiments, the electrical connector 100 may be a receptacle connector and the mating connector may be a plug connector 1. FIGS. 8A and 8B show a front perspective view and a front view, respectively, of the connector 100 and the plug connector 1 positioned for mating/unmating. Double-headed arrows in FIGS. 8A and 8B indicate mating/unmating directions. The connector 100 may be a mounted on a substrate 7, which may be a PCB comprising wiring and contact pads configured to contact portions of the first terminals 131 of the first terminal assembly 13 and the second terminals 151 of the second terminal assembly 151 to transmit electrical signals and/or power to and/or from the connector 100.

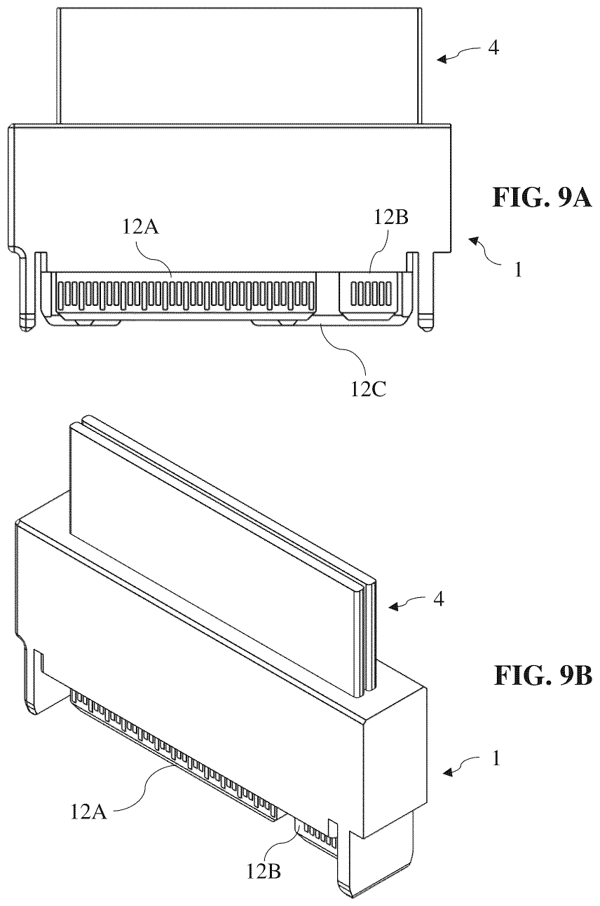

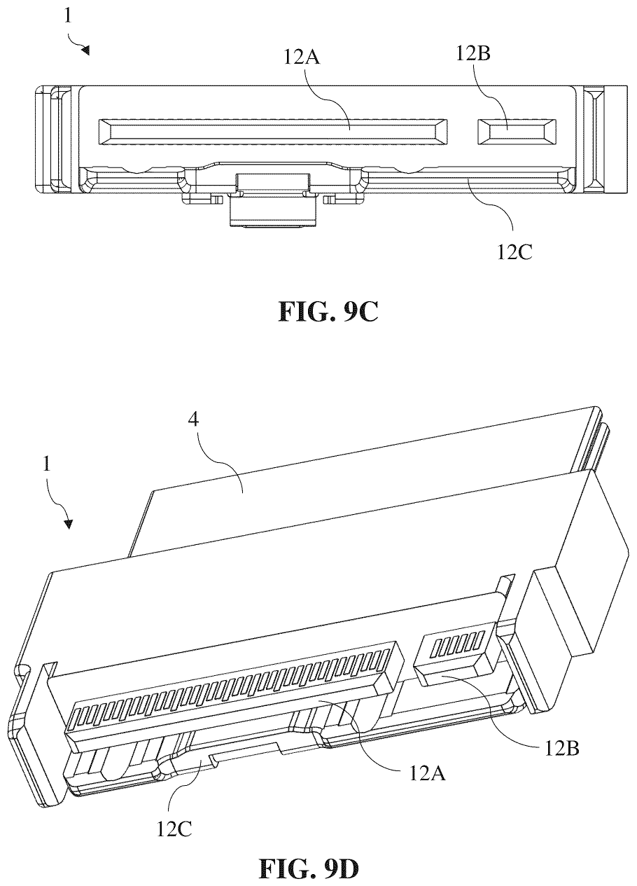

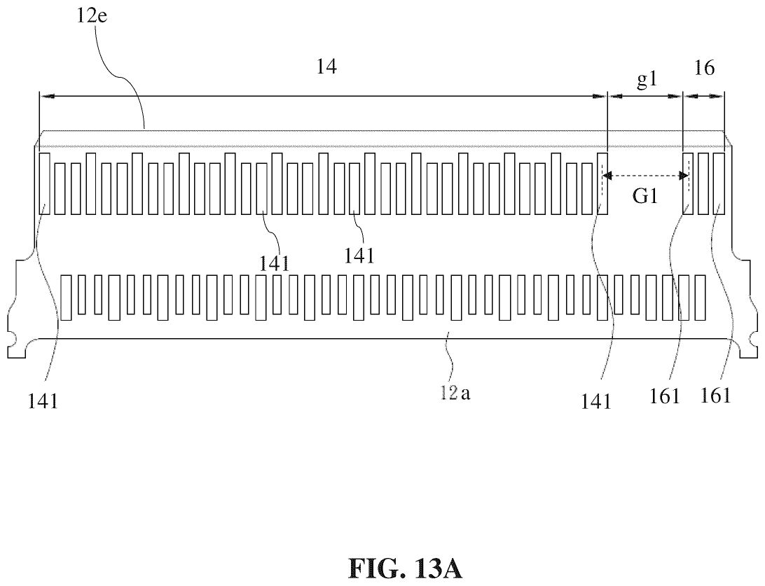

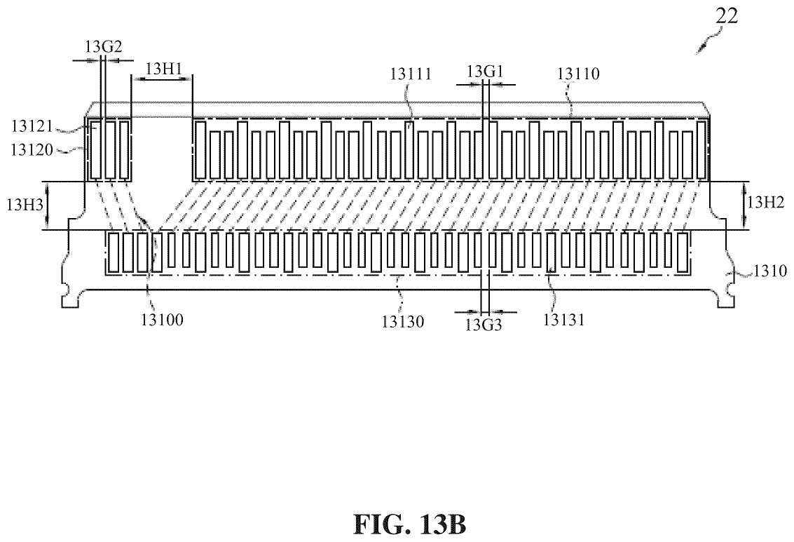

FIGS. 9A and 9B show a front view and a front perspective view of the plug connector 1. FIGS. 9C and 9D show a bottom view and a bottom perspective view of the plug connector 1. According to some embodiments, the plug connector 1 may comprise at least one protruding board or tongue configured to be inserted in the slot 110 of the connector 100. In some embodiments, the protruding board may comprise a plug circuit board 12, a portion of which is shown in FIG. 13. The plug circuit board 12 may comprise an insertion edge 12e and a plurality of conductive plug terminals near the insertion edge 12e and configured to contact the first and second terminals 131, 151 of the connector 100. In some embodiments, the plug terminals may comprise a first plug terminal assembly 14 comprising a plurality of first plug terminals 141 configured to contact the first terminals 131 when the plug connector 1 and the connector 100 are mated together, and may comprise a second plug terminal assembly 16 comprising a plurality of second plug terminals 161 configured to contact the second terminals 151 when the plug connector 1 and the connector 100 are mated together. In some embodiments, the first plug terminal assembly 14 and the second plug terminal assembly 16 may be separated by the same center-to-center pitch G1 or the same edge-to-edge pitch g1 discussed above, as illustrated in shown in FIG. 13.

In FIG. 13, the insertion edge 12e of the plug circuit board 12 is shown to be a single edge configured to be inserted into the slot 110 of the connector 100 before other portions of the plug circuit board 12. According to some embodiments, the plug connector 1 may comprise more than one protruding board configured to be inserted in the slot 110 of the connector 100. In some embodiments, the plug connector 1 may comprise a first plug board 12A and a second plug board 12B, as shown in FIGS. 8B and 9A through 9D. The first and second plug boards 12A, 12B, may be physically separate boards or may be separate portions extending from a common base. The first plug board 12A may comprise a first insertion edge and the second plug board 12B may comprise a second insertion edge spaced apart from the first insertion edge. In some embodiments, the first plug board 12A may comprise the first plug terminals 141 and the second plug board 12B may comprise the second plug terminals 161. The first plug terminals 141 and the second plug terminals 161 may comprise contact pads configured to physically contact portions of the first terminals 131 of the first terminal assembly 13 and the second terminals 151 of the second terminal assembly 151, respectively, to transmit electrical signals and/or power to and/or from the electrical connector 100.

According to some embodiments, the first plug terminal assembly 14 disposed on the first plug board 12A and the second plug terminal assembly 16 on the second plug board 12B may be separated by the same center-to-center pitch G1 (see FIGS. 8B and 13) or the same edge-to-edge pitch g1 (see FIG. 13) discussed above. Such an arrangement may enable the electrical connector 100 configured with plug connectors comprising a single insertion edge (e.g., the insertion edge 12e of the plug circuit board 12) or more than one insertion edge (e.g., the insertion edges of the first and second plug boards 12A, 12B).

According to some embodiments, the plug connector 1 may comprise an alignment protrusion 12C configured to be received in the sub-space 171 in the space 170. In some embodiments, the alignment protrusion 12C may comprise an outer edge that protrudes further than the insertion edge 12e of the plug circuit board 12 (or the insertion edges of the first and second plug boards 12A, 12B), as shown in FIG. 9A. Such a structure may require to the alignment protrusion 12C to engage with the electrical connector 100 before the plug circuit board 12 (of the first and second plug boards 12A, 12B) engage with the connector 100. This may prevent damage to the first and second terminals 131, 151 of the connector 1 and/or the first and second plug terminals 141, 161 due to misalignment of the plug connector 1 relative to the connector 100 during a mating operation.

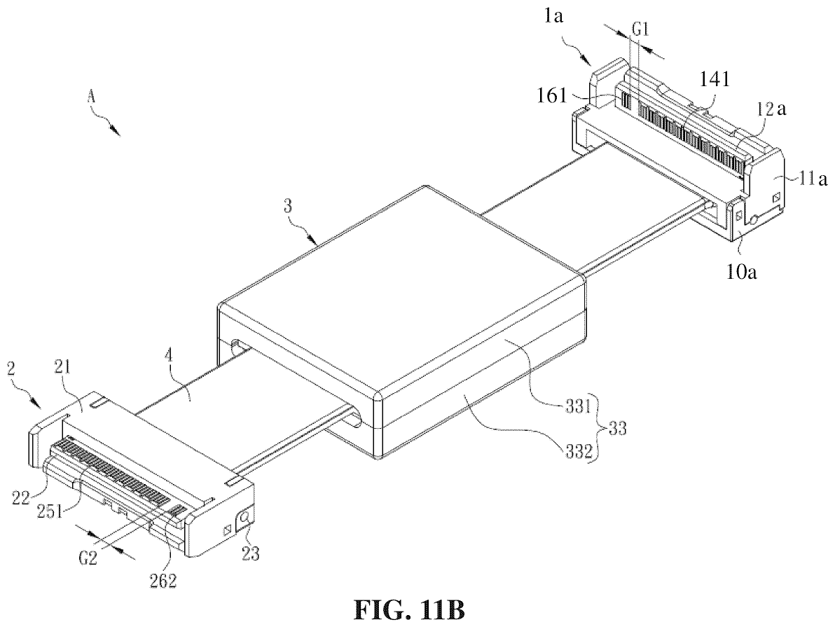

Returning to FIGS. 8A and 8B, the electrical connector 100 may be a mounted on the substrate 7, which may be a PCB of an electronic apparatus, and may be electrically connected to another electronic apparatus via a cable having first and second ends. According to some embodiments, the cable may comprise the plug connector 1 located at the first end, a second connector 2 located at the second end (see FIG. 11A), and cable 4 electrically connecting the plug connector 1 to the second connector 2. The plug connector 1 may be configured to mate with the electrical connector 100, as discussed above, and the second connector 2 may be configured to mate with another connector of the other electronic apparatus. The cable may be a passive cable configured to transmit one or more electrical signals between the connectors 1, 2 directly or an active cable configured to transmit one or more electrical signals between the connectors 1, 2 via active circuitry configured to modify the one or more electrical signals. The active circuitry may be located along the cable 4 and may be positioned anywhere between the connectors 1, 2 (e.g., near one end or the other or in an intermediate portion of the cable 4 of the active cable). For example, the active circuitry may include a circuit chip configured to convert an analog signal to a digital signal and/or to convert a type (e.g., analog or digital) of the one or more electrical signals to another type, and/or to amplify the one or more electrical signals, and/or to convert a format (e.g., HDMI, VGA, USB, etc.) of the one or more electrical signals to another format, etc.

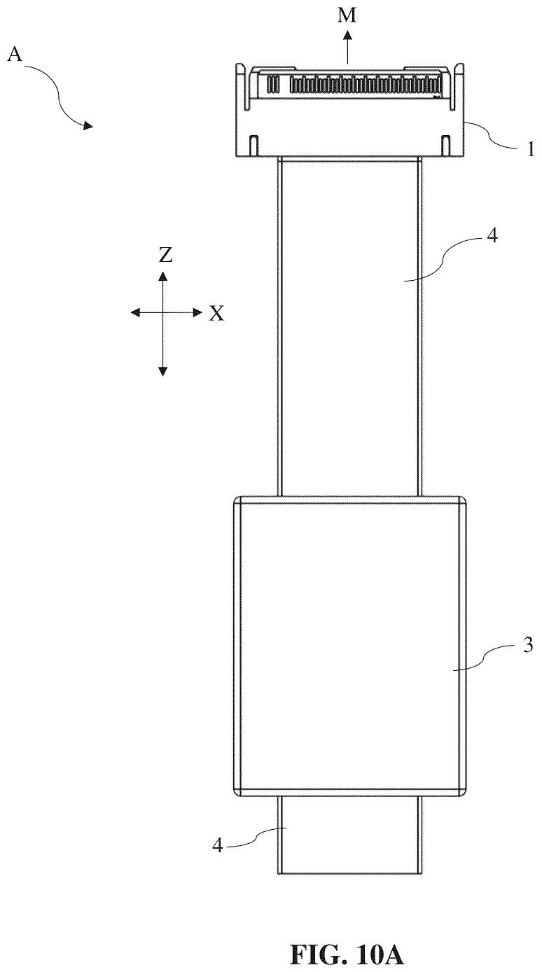

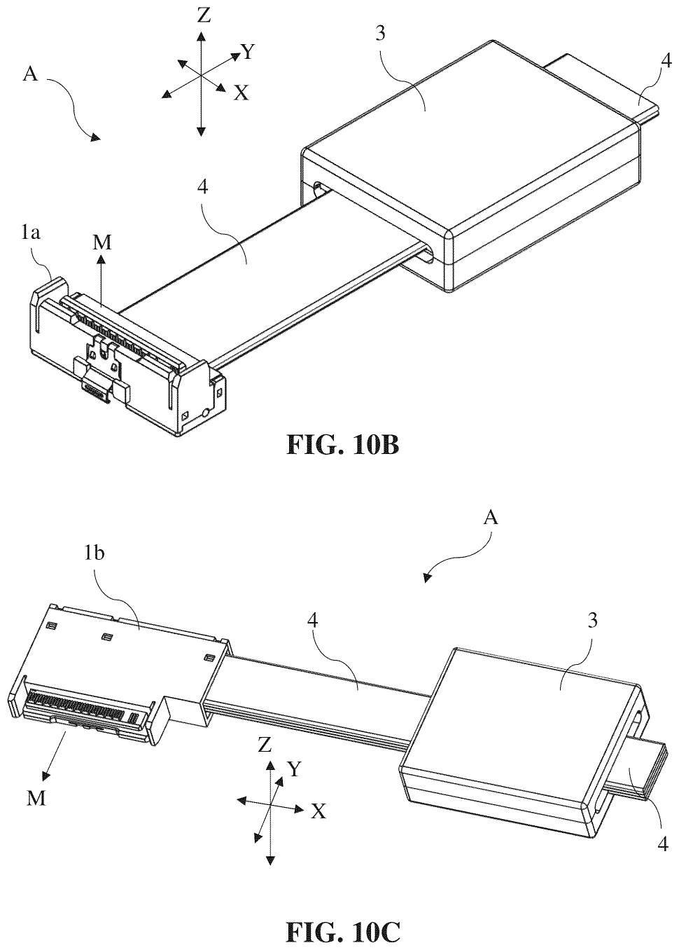

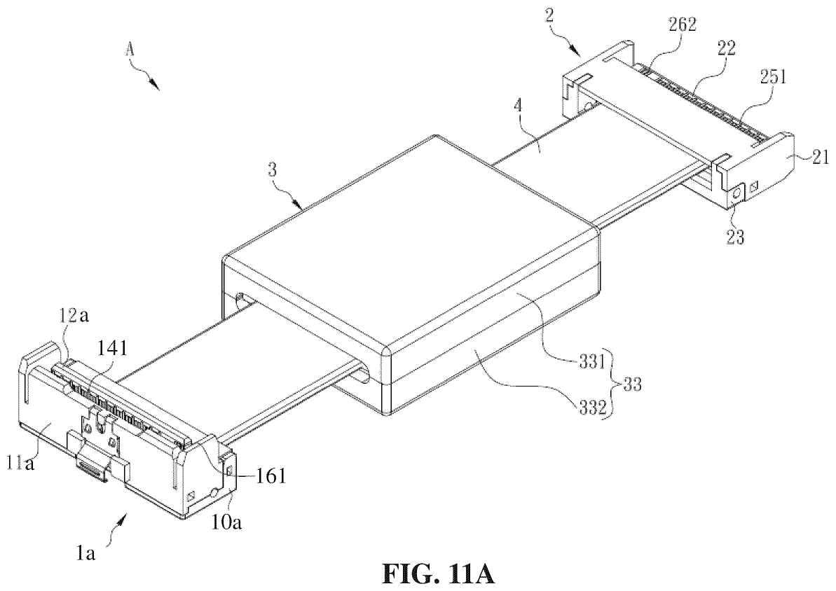

FIG. 10A shows a portion of an active cable A comprising the plug connector 1 at the first end of the cable A, the cable 4, and the active circuitry 3 located between the plug connector 1 and the second end (not shown) of the cable A, according to some embodiments. The plug connector 1 may be a vertical connector in which the cable 4 extends from the plug connector 1 in alignment with the mating direction M of the plug connector 1. For example, as shown in FIGS. 8A and 8B, the mating direction M may be parallel to the Z axis, and the cable 4 may extend from the plug connector 1 in alignment with the mating direction M. It should be appreciated that the cable 4 may be flexible, such that one or more portions of the cable 4 relatively farther from the first end of the cable A may not be in alignment with the mating direction M.

FIG. 10B shows a variation of the active cable A in which a plug connector 1a is located at the first end, instead of the plug connector 1. Unlike the plug connector 1, the plug connector 1a may be a right-angle connector in which the mating direction M may be parallel to the Z axis while the cable 4 may extend from the plug connector 1a in a direction parallel to the Y axis. FIG. 10C shows another variation of the active cable A in which a plug connector 1b is located at the first end, instead of the plug connector 1. Unlike the plug connector 1, the plug connector 1a may be a right-angle connector in which the mating direction M may be parallel to the Y axis while the cable 4 may extend from the plug connector 1b in a direction parallel to the X axis. It should be appreciated that other variations of the active cable A are possible and within the scope, even if not expressly illustrated in the drawings.

FIGS. 11A and 11B show top, front and bottom perspective views, respectively, of the active cable A of FIG. 10B, in which the plug connector 1a is located at the first end and a plug connector 2 is located at the second end of the cable A, according to some embodiments. In some embodiments, the active circuitry 3 may comprise a relay controller. To simplify the present discussion, the X axis may be referred to as the horizontal axis, the Z axis may be referred to as a vertical axis, and the Y axis may be referred to as a transverse axis. In some embodiments, the plug connector 1a may be horizontally elongated. Left and right directions of the plug connector 1a may extend parallel to the X axis, top and bottom directions of the plug connector 1a may extend parallel to the Z axis, and front and rear directions of the plug connector 1a may extend parallel to the Y axis. Thus, in FIG. 11A, a top front perspective view of the plug connector 1a and a top rear perspective view of the plug connector 2 are shown. In FIG. 11B, a top front perspective view of the plug connector 2 and a top rear perspective view of the plug connector 1a are shown.

According to some embodiments, the cable 4 may be configured to transmit signals or power. A first end (e.g., a front end) of the cable 4 may be electrically connected to the plug connector 1a, and a second (e.g., a rear end) of the cable 4 may be electrically connected to the plug connector 2, such that both the plug connector 1a and the plug connector 2 are configured to transmit signals or power. In some embodiments, the cable 4 may comprise a single wire or multiple wires. In some embodiments, the cable 4 may comprise a coaxial cable. In some embodiments, the cable 4 may comprising optical fibers.

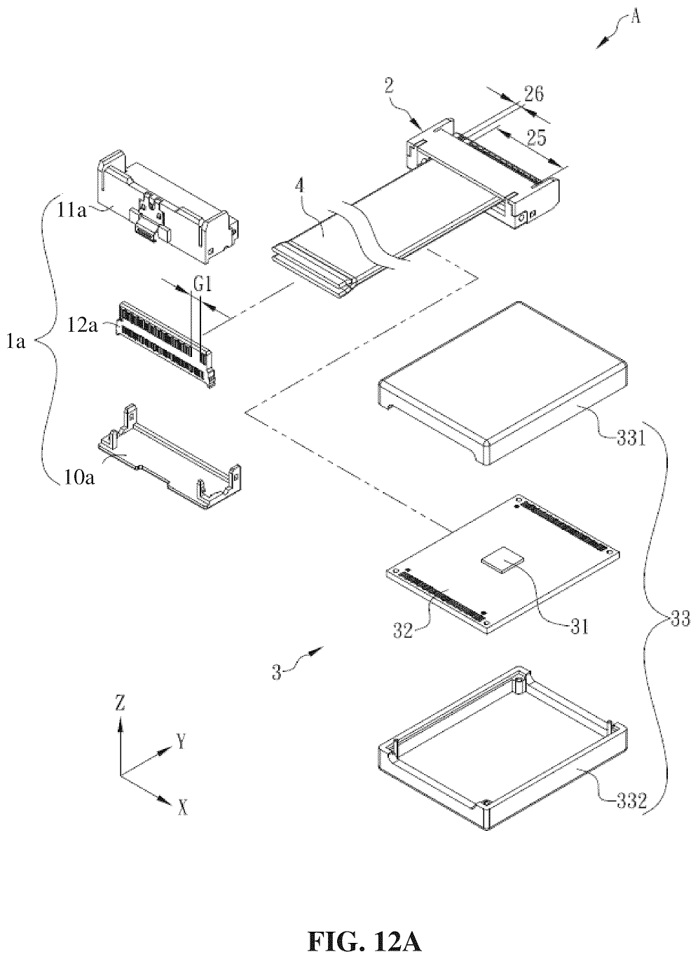

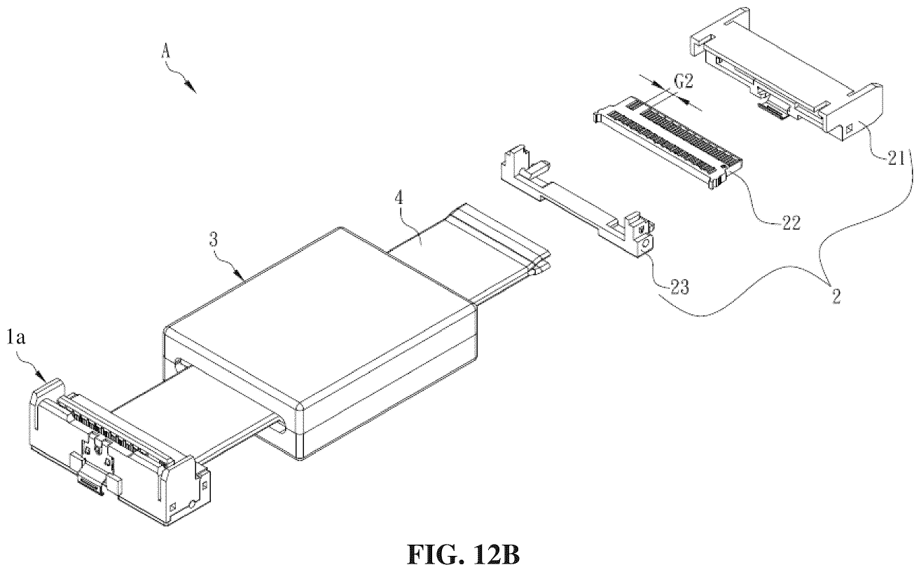

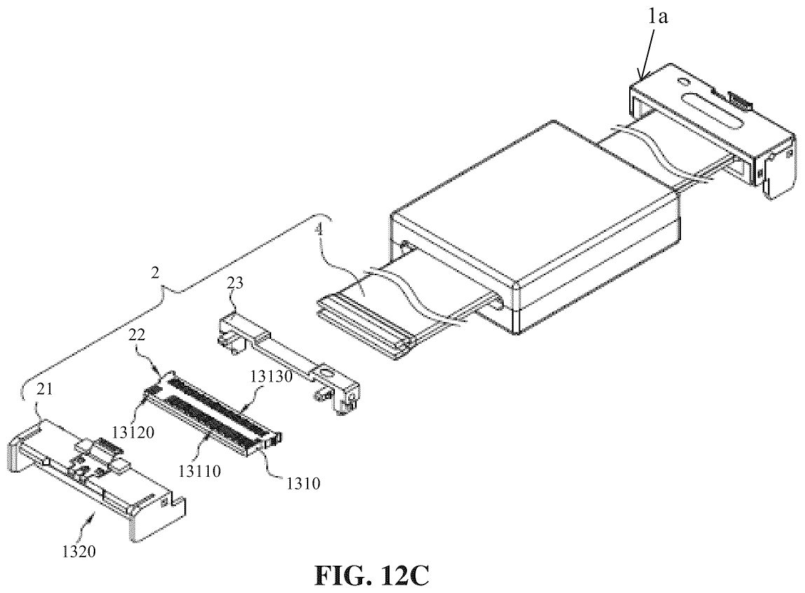

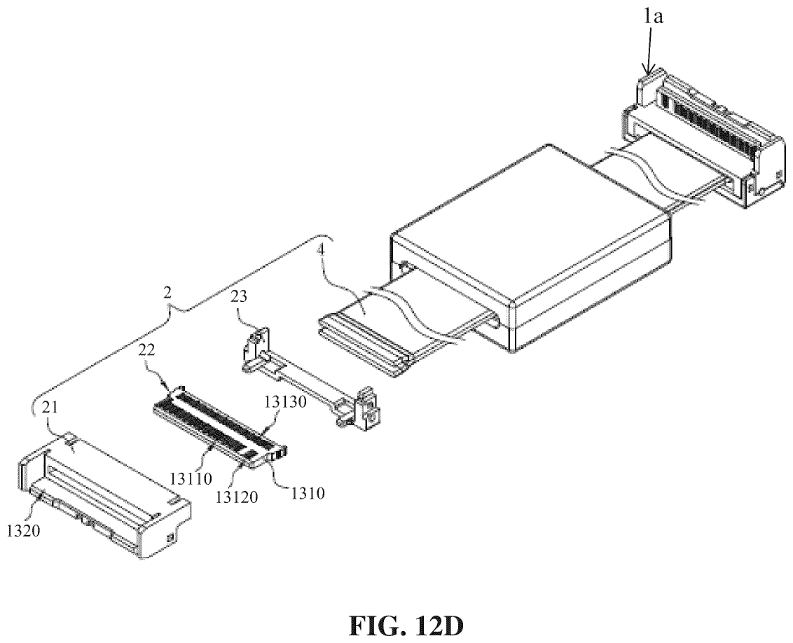

FIG. 12A shows a perspective view of the active cable A of FIG. 11A in which the plug connector 1a and the active circuitry 3 are depicted in partially disassembled states. FIG. 12B shows a perspective view of the active cable A in which the plug connector 2 is depicted in a partially disassembled state. FIG. 12C shows a bottom perspective view of the active cable A, showing the plug connector 2 in partially disassembly state. FIG. 12D shows a top perspective view of the active cable A, showing the plug connector 2 in partially disassembly state. According to some embodiments, the plug connector 1a may be an edge connector comprising a first housing 11a, a first circuit board 12a and a first housing 10a, as shown in FIG. 12A. The first circuit board 12a may be electrically connected to the cable 4 and may be disposed in the first housing 11a and arranged to contact a mating connector. In some embodiments, an insulative-material encapsulation technique may be used to fix the first circuit board 12a to the first housing 11a. In some embodiments, the first circuit board 12a may be mounted in the first housing 11a using a snap-fit technique. It should be appreciated that other fixing techniques may be used instead of or in addition to the insulative-material encapsulation technique and/or the snap-fit technique.

According to some embodiments, the first plug terminal assembly 14 comprising the first plug terminals 141 (e.g., conductive pads as shown) and the second plug terminal assembly 16 comprising the second plug terminals 161 (e.g., conductive pads as shown), discussed above, may be arranged on the first circuit board 12a, as shown in FIG. 13A. In some embodiments, the first plug terminal assembly 14 may comprise seventy four (74) first plug terminals 141. In some embodiment, the first plug terminals 141 may be distributed on two opposite surfaces (e.g., a front surface and a rear surface) of the first circuit board 12a, with thirty seven (37) first plug terminals 141 provided on one surface (e.g., the front surface) and thirty seven (37) first plug terminals 141 provided on the opposite surface (e.g., the rear surface). In some embodiments, the first plug terminals 141 may be arranged symmetrically on the two opposite surfaces of the first circuit board 12a. In some embodiments, the first plug terminals 141 may be arranged on a single side of the first circuit board 12a or may be arranged asymmetrically on the two opposite surfaces of the first circuit board 12a. In some embodiments, the two opposite surfaces of the first circuit board 12a may support different numbers of the first plug terminals 141.

In some embodiments, the second plug terminal assembly 16 may comprise three (3) second plug terminals 161. In some embodiment, the second plug terminals 161 may be distributed on the two opposite surfaces of the first circuit board 12a, with at least one second plug terminal 161 provided on one surface and at least one second plug terminals 161 provided on the opposite surface. In some embodiments, no more than three second plug terminals 161 may be provided on each of the two opposite surfaces of the first terminal board 12a. The second plug terminals 161 may be arranged or symmetrically or asymmetrically on the two opposite surfaces of the first circuit board 12a. In some embodiments, the second plug terminals 161 may be arranged on a single side of the first circuit board 12a. In some embodiments, the two opposite surfaces of the first circuit board 12a may support different numbers of the second plug terminals 161.

In some embodiments, the number and arrangement of first plug terminals 141 may conform to specifications of a first interface standard, and the number and arrangement of the second plug terminals 161 may conform to specifications of a second interface standard different from the first interface standard. In some embodiments, the first plug terminal assembly 14 and the second plug terminal assembly 16 may not conform to any interface standard, or may conform to a single interface standard. In some embodiments, only one of the first and second plug terminal assemblies 14, 16 conforms to an interface standard, while the other one of the first and second plug terminal assemblies 14, 16 may not conform to any interface standard.

According to some embodiments, the first plug terminals 141 and the second plug terminals 161 may be electrically connected to respective circuits (not shown) on the first circuit board 12a. The circuits on the first circuit board 12a may be electrically connected to the cable 4, which may connect the circuits to various electronic components via the plug connector 2 at the second end of the active cable A.

As noted herein, the first plug terminal assembly 14 and the second plug terminal assembly 16 may be separated by a center-to-center pitch G1 and/or an edge-to-edge pitch g1 between and an end one of the first plug terminals 141 and a nearest end one of the second plug terminals 161, as shown in FIG. 13A. In some embodiments, the first and second plug terminals 141, 161 may comprise planar contact surfaces (e.g., contact strips) configured to engage with corresponding contact fingers of a mating connector. A region between the end one of the first plug terminals 141 and a nearest end one of the second plug terminals 161, e.g., a region within the pitches G1 and g1, may be devoid of any terminal. In some embodiments, this region may be a solid surface that is devoid of any terminal, as shown in FIG. 13A. In some embodiments, this region may be a groove or a recess in the first circuit board 12a, as discussed above in connection with FIGS. 9A through 9D.

According to some embodiments, the center-to-center pitch G1 may be greater than a center-to-center pitch between adjacent first plug terminals 141 and greater than a center-to-center pitch between adjacent second plug terminals 161. In some embodiments, the edge-to-edge pitch g1 may be greater than an edge-to-edge pitch between adjacent first plug terminals 141 and greater than an edge-to-edge pitch between adjacent second plug terminals 161. In some embodiments where the first plug terminals 141 are located on both sides of the first circuit board 12a, the first plug terminals 141 on one side of the first circuit board 12a may be aligned with and directly opposite the first plug terminals 141 on the other side of the first circuit board 12a, such that the pitches G1 and g1 on opposite sides of the first circuit board 12a are aligned.

According to some embodiments, the first housing 10a may surround at least a portion of the first housing 11a and may effectively prevent electromagnetic interference (EMI). For example, the first housing 10a may be metallic and may be grounded or electrically connected to earth to protect the first housing 11a from EMI. In some embodiments, the first housing 10a may be a shell that serves to increase strength and durability of the plug connector 1a. In some first embodiments, the first housing 10a may be U-shaped, e.g., the first housing 10a may have only three sides. In some embodiments, the first housing 10a may be a rectangular frame structured to surround four sides of the first housing 11a. In some embodiments, the plug connector 1a may not be provided with the first housing 10a.

According to some embodiments, when the plug connector 1a is mated with a mating connector, the first plug terminal assembly 14 and the second plug terminal assembly 16 may both be used for exchanging signals or power with the mating connector. In some embodiments, one of the first and second plug terminal assemblies 14, 16 may be used for exchanging signals while the other may be used for exchanging power.

According to some embodiments, the plug connector 2 at the second end of the active cable A may be an edge connector comprising a second housing 21, a second circuit board 22 and a second housing 23, as shown in FIG. 12B. In some embodiments, the second housing 23 may surround at least a portion of the second housing 21 and may effectively reduce the risk of electromagnetic interference (EMI), similar to the first housing 10a discussed above. In some embodiments, the second housing 23 may be a shell that serves to increase strength and durability of the plug connector 2. In some embodiments, the second circuit board 22 may be mounted in the second housing 21 and may be arranged to engage with a mating connector. In some embodiments, the second circuit board 22 may be provided with a third plug terminal assembly 25 and a fourth plug terminal assembly 26.

According to some embodiments, the third plug terminal assembly 25 may be similar in many respects to the first plug terminal assembly 14 discussed above. For example, the third plug terminal assembly 25 may comprise a plurality of third plug terminal 251 equal in number to the number of first plug terminals 141 of the first plug terminal assembly 14, and may conform to a same interface standard as that of the first plug terminal assembly 14. Similarly, the fourth plug terminal assembly 26 may be similar in many respects to the second plug terminal assembly 16 discussed above. For example, the fourth plug terminal assembly 26 may comprise a plurality of fourth plug terminals 262 equal in number to the number of second plug terminals 161 of the plug terminal assembly 16, and may conform to a same interface standard as that of the second plug terminal assembly 16. In some other embodiments, the number of third plug terminals 251 included in the third plug terminal assembly 25 may be different from the number of first plug terminals 141 included in the first plug terminal assembly 14, and the number of fourth plug terminals 262 included in the fourth plug terminal assembly 26 may be different from the number of second plug terminals 161 included in the second plug terminal assembly 16. In some embodiments, the second circuit board 22 may be provided with only one plug terminal assembly (e.g., the third plug terminal assembly 25). In some embodiments, the plug connector 2 may not be an edge connector may be another type of connector (e.g., a high-definition multimedia interface (HDMI) connector, an optical fiber connector, a bayonet Neill-Councilman (BNC) connector, etc.).

According to some embodiments, the third plug terminal assembly 25 and the fourth plug terminal assembly 26 may be separated by a pitch G2, which may be a center-to-center pitch or an edge-to-edge pitch between and an end one of the third plug terminals 251 and a nearest end one of the fourth plug terminals 262, as shown in FIG. 12B. In some embodiments, the third and fourth plug terminals 251, 262 may comprise planar contact surfaces (e.g., contact strips) configured to engage with corresponding contact fingers of a mating connector. A region between the end one of the third plug terminals 252 and a nearest end one of the fourth plug terminals 262, e.g., a region within the pitch G2, may be devoid of any terminal. In some embodiments, this region may be a solid surface that is devoid of any terminal of may be a groove in the second circuit board 22.

According to some embodiments, the active circuitry 3 may be disposed along the cable 4 between the plug connector 1a at the first end of the active cable A and the plug connector 2 at the second end of the active cable A. The active circuitry 3 need not bisect the cable 4 but may be positioned anywhere along the length of the cable 4. In some embodiments, the active circuitry 3 may comprise a relay controller, as noted above.

According to some embodiments, the active circuitry 3 may comprise at least one control chip 31 supported by a circuit board 32, as depicted in FIG. 12A. Internal wiring of the circuit board 32 may connect circuits of the control chip(s) 31 to conductive terminals on the circuit board 32. The conductive terminals may be, e.g., contact pads to which wires of the cable 4 may be electrically connected. In some embodiments, the conductive terminals may be located on opposite sides of the control chip(s) 31 such that signals and/or power transmitted from one of the plug connectors 1a, 2 may enter one side of the control chip(s) 31 and exit the other side of the control chip(s) 31 toward the other one of the plug connectors 1a, 2. In some embodiments, the control chip(s) 31 may be configured to perform a predetermined intermediary process on the transmitted signals and/or power (“signal/power”). For example, one or more of the circuits of the control chip(s) 31 may control a signal/power enhancement process to change one or more signal/power amplitudes, or may control a signal/power shaping processing to change a phase or other signal/power characteristic, or may control a signal/power conversion process to change a transmission format or a protocol, or may control an error checking process, or may control a signal timing of one or more signals, to name a few types of intermediary processes that may be performed by the circuits of the control chip(s) 3. In some embodiments, the active circuitry 3 may comprise a protective shell 33, the protective shell 33, which may be formed of first and second shell portions 331, 332. In some embodiments, the circuit board 32 may be housed within the protective shell 33. For example, the first shell portion 331 may serve as a top cover and the second shell portion 332 may serve as a bottom cover covering the circuit board 32 to prevent the circuit board 32 and the control chip(s) 31 from being damaged by an external force debris. It should be appreciated that the protective shell 33 may comprise openings through which portions of the cable 4 may extend. In some embodiments, the protective shell 33 may be formed of a unitary structure in which the circuit board 32 and the control chip(s) 31 may be inserted, or may comprise more than two portions. In some embodiments, the active circuitry 3 may not be provided with a protective covering. In some embodiments, the circuit board 32 and the control chip(s) 31 may be part of the plug connector 1a or the plug connector 2.

According to some embodiments, similar to the first and second plug terminal assemblies 14, 16, the third and fourth plug terminal assemblies 25, 26 may be configured to transmit signals or power or both signals and power. Also, similar to the plug connector 1a, the plug connector 2 may be a vertical connector or a right-angle connector.

Referring to FIGS. 12C, 12D, 13B, the circuit board 22 includes a substrate 1310, a first group of conductive pads 13110, a second group of conductive pads 13120 and a third group of conductive pads 13130. The substrate 1310 may include conductive circuit 13100. According to product requirements, the substrate 1310 can be in a single-layer, double-layer or multi-layer form. It should be appreciated that when the substrate 1310 is in a single-layer form, the circuit board 22 is a single-layer circuit board (Single-Layer PCB); when the substrate 1310 is in a double-layer form, the circuit board 22 is a Double-Layer PCB; and when the substrate 1310 is in a multi-layer form, the circuit board 22 is a multilayer PCB. According to the production technology and product requirements, the conductive trace 13100 may be embedded in the substrate 1310 and not visible on a surface of the substrate 1310.

The first group of conductive pads 13110, the second group of conductive pads 13120 and the third conductive pad can be respectively provided on opposite sides of the substrate 1310 (such as the top side and the bottom side). In other embodiments of the present disclosure, the circuit board 22 can only have a single group of first conductive pads 13110, a single group of second conductive pads 13120, and a single group of third conductive pads. The subsequent description will describe the component arrangement on one side of the substrate 1310. It should be appreciated that the component configurations on opposite sides of the substrate 1310 can be the same.

As shown in FIG. 13B, the first group of conductive pads 13110 and the second group of conductive pads 13120 can be at the same transverse axis position and separated from each other by a first separation distance 13H1. The third group of conductive pads 13130 and the second group of conductive pads 13110 are at different transverse axis positions and is separated from each other by a second separation distance 13H2. The third group of conductive pads 13130 and the second group of conductive pads 13120 are at different transverse axis positions and are separated from each other by a third separation distance 13H3. As illustrated, the first group of conductive pads 13110 and the second group of conductive pads 13120 are arranged along the X-axis direction, and the first group of conductive pads 13110 and the third group of conductive pads 13130 are arranged along the Y-axis direction, the second group of conductive pads 13120 and the third group of conductive pads 13130 are also arranged along the Y-axis direction. The third group of conductive pads 13130 is electrically connected to the first group of conductive pads 13110 and the second group of conductive pads 13120 through corresponding conductive lines 13100, such that the first group of conductive pads 13110 and the second group of conductive pads 13120 can respectively transmit power and signals to and from the third group of conductive pads 13130.

As illustrated, the first group of conductive pads 13110 includes a plurality of first conductive pads 13111. The first conductive pads 13111 are arranged along the horizontal axis, and are separated from each other by a distance G1. In some embodiments, the first group of conductive pads 13110 can include 37 first conductive pads 13111. Two sets of first groups of conductive pads 13110 may be included on opposite sides of the substrate 1310. The total number (for example: 74 pieces) and arrangement of the first conductive pads 13111 can comply with the specifications of a first interface standard. The second group of conductive pads 13120 includes a plurality of second conductive pads 13121, the second conductive pads 13121 are arranged along the horizontal axis and are spaced apart from each other by a distance G2. In some embodiments, the second group of conductive pads 13120 can include 22 to 3 second conductive pads 13121. Two sets of second conductive pads 13120 may be included on opposite sides of the substrate 1310. The total number (for example: 2 to 6 pieces) and arrangement of the second conductive pads 13121 can comply with a second interface standard. The second interface standard can be different from the first interface standard. In other embodiments of the present disclosure, both the first conductive pads 13111 and the second conductive pads 13121 can be integrated into a single interface standard, or only one of the groups of conductive pads conforms to a corresponding interface standard, etc.

As illustrated, the third group of conductive pads 13130 includes a plurality of third conductive pads 13131. The third conductive pads 13131 are arranged along the horizontal axis direction. The third conductive pads 13131 are arranged and spaced apart from each other by a distance G3. In some embodiments, the third group of conductive pads 13130 can include 38 to 40 third conductive pads 13131. The number of the third conductive pads 13131 may be the same as a sum of the number of the first conductive pads 13111 and the second conductive pads 13121.

As illustrated, the first group of conductive pads 13110 and the second group of conductive pads 13120 are separated from each other by a first separation distance 13H1. The first group of conductive pads 13110 and the third group of conductive pads 13130 are separated from each other by a second separation distance 13H2. The second group of conductive pads 13120 and the third group of conductive pads 13130 are separated from each other by a third separation distance 13H3. In the illustrated example, the second separation distance 13H2 is substantially the same as the third separation distance 13H3. A combined length of the first group of conductive pads 13110, the first separation distance 13H1 and the second group of conductive pads 13120 is greater than a length of the third group of conductive pads 13130. Although dashed boxes are used to illustrate areas of individual groups of conductive pads, it should be appreciated that the boxes are schematic illustrations, and the present disclosure is not intended to be limited to the illustrated boxes. For example, although the first separation distance 13H1 is illustrated as a distance between two dashed boxes that are offset from edges of respective contact pads, it should be appreciated that the first separation distance 13H1 may be the distance between adjacent edges of a first contact pad 13111 and a second contact pad 13121.

The first separation distance 13H1, the second separation distance 13H2 and the third separation distance 13H3 can be at least larger than a distance 13G1 between any adjacent first conductive pads 13111, a 13G2 between any adjacent second conductive pads 13121, and a distance 13G3 between any adjacent third conductive pads 13131. In the illustrated example, no conductive pad (or gold finger) are provided within the range of the first separation distance 13H1, the second separation distance 13H2 and the third separation distance 13H3. The circuit board 22 (or the area of the substrate 1310) corresponding to the first separation distance 13H1 is substantially solid rather than grooved.

As shown in the figures, one end (such as the front end) of the housing 21 is provided with a docking space 1320 in which the circuit board 22 is disposed. The first group of conductive pads 13110 and the second group of conductive pads 13120 are exposed in the docking space 1320, so as to be electrically connected to the conductive element of another connector. In addition, one end of the cable 4 can be electrically connected to the third group of conductive pads 13130. In some embodiments, the circuit board 22 and the cable 4 can be fixed into the housing 21 using insulating material packaging technology. In other embodiments of the invention, the circuit board 22 can be installed into the housing 21 by inserting cards or other methods. In some embodiments, the shell 3 can be assembled to the outside of the housing 21, so that the shell 3 can reduce the risk of electromagnetic interference (EMI), serve as a grounding path, and protect the housing 21. It can also improve the overall strength and durability of the line end connector C.

The circuit board 22 can transmit power and/or signals between another connector and the cable 4 through the first group of conductive pads 13110. The layout arrangement of the second group of conductive pads 13120 and the third group of conductive pads 13130 can facilitate circuit adjustment and optimize component layout to provide better design flexibility. For example, the front half of the circuit board 22 may be provided with a plurality of groups of conductive pads (e.g., the first group of conductive pads 13110 and the second group of conductive pads 13120). In such a way, the line end connector 2 can be connected to various hardware and equipment to improve its compatibility. The rear half of the circuit board 22 may be provided with another group of conductive pads (e.g., the third group of conductive pads 13130). The third group of conductive pads 13130 may be electrically connected to the core wires of the cable 4. Such a configuration eliminates the requirement to adapt the third group of conductive pads 13131 according to the interface standards of various hardware and equipment, and therefore enables arranging the third group of conductive pads 13131 at equal intervals, which may make cable attachment easier and more reliable.

The active cable A has been described to include two plug connectors, e.g., the plug connector 1a and the plug connector 2. According to some embodiments, an active cable may comprise two receptacle connectors or one receptacle connector and one plug connector.

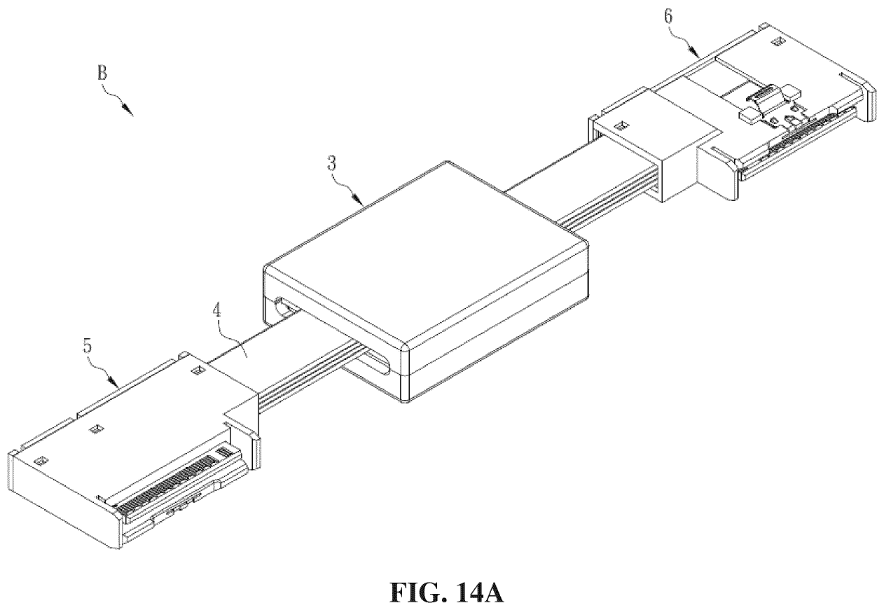

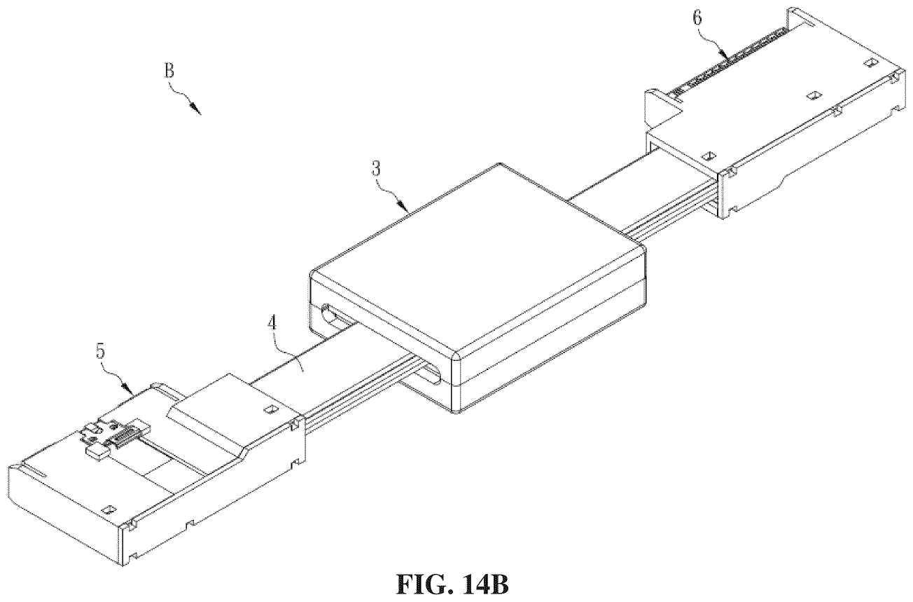

FIGS. 14A and 14B show a top perspective view and a bottom perspective view, respectively, of an active cable B, according to some embodiments. The active cable B may comprise the cable 4, a plug connector 5 disposed at a first end of the cable 4, a receptacle connector 6 disposed at a second end of the cable 4, and the active circuitry 3 positioned at or between the first and second ends. It should be appreciated that although the cable 4 is depicted to extend orthogonally from the mating directions of the connectors 5, 6, the connectors 5, 6 need not be right-angle connectors and may instead be different types of connectors.

Additionally, although the mating directions of the connectors 5, 6 are depicted to be parallel to each other, in some embodiments the connectors 5, 6 may be oriented such that the mating directions are antiparallel to each other.

### Examples

In a first example, an electrical connector may comprise a first terminal assembly comprising a plurality of first conductive elements, and a second terminal assembly comprising a plurality of second conductive elements. An housing with a slot in which portions of the first and second terminal assemblies may be arranged to contact a mating connector when the electrical connector is mated with the mating connector. The first and second terminal assemblies may be aligned in a row direction, and separated from each other by a predetermined distance.

Such an electrical connector optionally may include one or more of the following features of characteristics:
the first terminal assembly may conform to a first interface standard;
the second terminal assembly may conform to a second interface standard different from the first interface standard;
the predetermined distance may be greater than a spacing between adjacent first conductive elements;
the predetermined distance may be greater than a spacing between adjacent second conductive elements;
the predetermined distance may be a center-to-center pitch between first and second conductive elements nearest each other;
the predetermined distance may be an edge-to-edge pitch between first and second conductive elements nearest each other;
the predetermined distance may be an edge-to-edge pitch equal to or greater than 4.13 mm;
the first terminal assembly may comprise a first number of first conductive elements, and the second terminal assembly may comprise a second number of second conductive elements different from the first number;
the first number may be 37, and the second number may be in a range of 1 to 3;
the electrical connector may also include a third terminal assembly comprising a plurality third conductive elements, and a fourth terminal assembly comprising a plurality of fourth conductive elements; the third conductive elements may be identical to the first conductive elements, the fourth conductive elements may be identical to the second conductive elements, the third and fourth terminal assemblies may be aligned in a second first row, the third and fourth terminal assemblies are separated from each other by the predetermined distance; the first and second rows may be arranged on opposite sides of the slot of the housing such that the first and second terminal assemblies of the first row may be arranged to contact a first side of a board of a mating connector when the electrical connector is mated with the mating connector, and the third and fourth terminal assemblies of the second row may be arranged to contact a second side of the board of the mating connector when the electrical connector is mated with the mating connector;
the first and third terminal assemblies may directly face each other, the second and fourth terminal assemblies may directly face each other, and the predetermined distance separating the third and fourth terminal assemblies may directly face the predetermined distance separating the first and second terminal assemblies;
a region of the slot corresponding to the first and third terminal assemblies may have a same width L as a region of the slot corresponding to the second and fourth terminal assemblies;
the slot may have a uniform width L in region corresponding to the first and second rows;
a region of the slot corresponding to the predetermined distances of the first and second rows may have a width no less than the width L; and
the first conductive elements may each comprise a first mating portion, a first tail portion, and a first intermediate portion, the second conductive elements may each comprise a second mating portion, a second tail portion, and a second intermediate portion, and a first angle between the first mating portion and the first intermediate portion may be different from a second angle between the second mating portion and the second intermediate portion.

In another example, an active cable may comprise cable having a first end and a second end. A first electrical connector may be located at the first end of the cable, and a second electrical connector may be located at the second end of the cable. Active circuitry may be located between the first and second ends of the cable. The active circuitry may comprise a circuit board electrically connected the cable, and at least one control chip supported by the circuit board and electrical connected to internal wiring of the circuit board. The first electrical connector may comprise a first terminal assembly comprising a plurality of first conductive elements, at second terminal assembly comprising a plurality of second conductive elements, a housing with a slot in which portions of the first and second terminal assemblies are arranged to contact a mating connector when the first electrical connector is mated with the mating connector. The first and second terminal assemblies may be aligned in a first row and may be separated from each other by a predetermined distance.

Such an active cable optionally may include one or more of the following features or characteristics:
the first terminal assembly may conform to a first interface standard;
the second terminal assembly may conform to a second interface standard different from the first interface standard;
the predetermined distance may be greater than a spacing between adjacent first conductive elements;
the predetermined distance may be greater than a spacing between adjacent second conductive elements;
the first electrical connector may also comprise a circuit board on which the first terminal assembly and the second terminal assembly are disposed, and the first conductive elements of the first terminal assembly and the second terminals of the second terminal assembly may comprise conductive contact strips located along at least one edge of the circuit board;
the predetermined distance may correspond to a region of the circuit board devoid of a conductive element;
the predetermined distance may correspond to a groove in the circuit board separating the first terminal assembly from the second terminal assembly;
the first terminal assembly may comprise a first number of first conductive elements, and the second terminal assembly may comprise a second number of second conductive elements different from the first number;
the first number may be 37, and the second number may be in a range of 1 to 3;
the first electrical connector may also comprise a third terminal assembly comprising a plurality third conductive elements, and a fourth terminal assembly comprising a plurality of fourth conductive elements; the third conductive elements may be identical to the first conductive elements, the fourth conductive elements may be identical to the second conductive elements, the third and fourth terminal assemblies may be aligned in a second first row, the third and fourth terminal assemblies may be separated from each other by the predetermined distance, and the third and fourth terminal assemblies may be located on an opposite side of the circuit board from the first and second terminal assemblies;
the first and third terminal assemblies may be aligned on opposite sides of the circuit board, the second and fourth terminal assemblies may be aligned on opposite sides of the circuit board, and the predetermined distance separating the third and fourth terminal assemblies may be aligned with the predetermined distance separating the first and second terminal assemblies, on opposite sides of the circuit board;
the first and second electrical connectors may be plug connectors;
the first electrical connector may be a plug connector and the second electrical connector may be a receptacle connector; and
the first electrical connector may be a vertical connector and second electrical connector may be a right-angle connector.

In another example, a connector with multiple terminal assemblies in a same slot may comprise a housing with at least one slot opened at one end inward, each slot comprising two opposite long sides and two opposite short sides; at least one first terminal assembly disposed in the housing and complying with the specifications of a first interface standard; and at least one second terminal assembly disposed in the housing. Each first terminal assembly may include a plurality of first conductive elements. At least part of each first conductive element may be exposed in the corresponding slot. Each second terminal assembly may include at least one second conductive element. At least part of each second conductive element may be exposed in the corresponding plug slot. The adjacent first terminal assembly and the second terminal assembly may be separated from each other by a terminal assembly spacing, and the terminal assembly spacing is at least greater than a first spacing between any adjacent first conductive elements. The distance between the two long sides of the housing may be no less than the terminal assembly spacing.

Such an electrical connector optionally may include one or more of the following features or characteristics:
the number of the first conductive elements in the first terminal assembly may be 74, and the number of the second conductive elements in the second terminal assembly may be 2 to 6;
the connector may further include a shell, and an assembly space may be provided in the shell for the housing to be accommodated therein;
the second terminal assembly may include a plurality of second conductive elements, and the spacing of the terminal assembly may be greater than the second spacing between any adjacent second conductive elements;
the two long sides of the housing may respectively correspond to the adjacent parts of the first terminal assembly and the second terminal assembly, and the distance between the terminal assemblies may extend substantially parallel to each other at the same distance apart;
the second terminal assembly may comply with the specifications of a second interface standard, and the second interface standard may be different from the first interface standard;
at one of the transverse axis positions, at least part of the first conductive elements and at least one second conductive element may be arranged in the same horizontal axis direction, and when viewed from the side, at least the intermediate portion of the second conductive element may have a greater bending amplitude than the intermediate portion of the first conductive element and may be further away from the central vertical axis of the slot;
each of the first conductive elements and each of the second conductive elements arranged at the same transverse axis position, viewed from the side, do not overlap except for the intermediate portion;
the connector may further comprise at least one first assembly housing holding the first conductive elements; and
the first conductive elements held by the first assembly housing may be disposed in the housing, and the second conductive elements may be directly disposed in the housing.

In another example, a connector with terminal assemblies at a specific pitch from each other may comprise at least one first terminal assembly conforming to specifications of a first interface standard, each first terminal assembly comprising a plurality of first conductive elements. The connector may also comprise at least one second terminal assembly, each comprising at least one second conductive element. An insulating body may include one end recessed inwardly to form at least one slot, at least one of the first terminal assemblies and one of the second terminal assemblies being mounted in the same slot. The first terminal assembly and the second terminal assembly that may be adjacent to each other may be separated from each other by a pitch of not less than 4.13 mm.

Such an electrical connector optionally may include one or more of the following features or characteristics:
the number of first conductive elements in the same first terminal assembly may be 74, and the number of second conductive elements in the same second terminal assembly may be 2 to 6;
in the first terminal assembly and the second terminal assembly that may be adjacent to each other, the first conductive element closest to the second terminal assembly and the second conductive element closest to the first terminal assembly have respective central vertical axes substantially parallel to each other, and may be separated from each other by the pitch;
a housing, in which a space may be provided for receiving the insulating body therein;
the second terminal assembly conforms to specifications of a second interface standard, and the second interface standard may be different from the first interface standard;
the pitch may be at least greater than a first spacing between any adjacent first conductive elements, the first spacing referring to a distance between the central vertical axes of the adjacent first conductive elements;
the second terminal assembly comprises a plurality of second conductive elements, and the pitch may be greater than a second spacing between any adjacent second conductive elements, the second spacing referring to a distance between the central vertical axes of the adjacent second conductive elements;
in one of transverse axis positions, at least some of the first conductive elements and at least one of the second conductive elements may be arranged in the same horizontal axis direction, and when viewed from the side, at least a intermediate portion of the second conductive element has a larger bending degree than a intermediate portion of the first conductive element and may be farther away from a central vertical axis of the slot;
when viewed from the side, each of the first conductive elements and each of the second conductive elements arranged in the same transverse axis position substantially keep overlapping except that the intermediate portions thereof do not overlap;
at least one first terminal assembly housing, each first terminal assembly housing being provided with the corresponding first conductive element; and
each first conductive element may be assembled into the insulating body together with the corresponding first terminal assembly housing, and each second conductive element may be directly disposed in the insulating body.

In another example, an active cable with multiple terminal assemblies may comprise a transmission line, and a first connector electrically connected to one end of the transmission line. A first circuit board may be provided in the first connector, and the first circuit board may be provided with a first plurality of conductive pads and a second plurality of conductive pads. The first plurality of conductive pads may comprise multiple first conductive sheets, the second plurality of conductive pads may comprise multiple second conductive sheets, and the first plurality of conductive pads and the second plurality of conductive pads may be separated from each other by a first separation distance. A second connector may be electrically connected to the other end of the transmission line. A relay controller may comprise at least one control chip and a relay circuit board. The control chip may be located on the relay circuit board, and the relay controller may be electrically connected to the transmission line.

Such an active cable optionally may include one or more of the following features or characteristics:
the first separation distance may be at least greater than a spacing between any adjacent first conductive sheets;
the first separation distance may be also greater than a spacing between any adjacent second conductive sheets;
a second circuit board may be provided in the second connector, the second circuit board may be provided with a third plurality of conductive pads and a fourth plurality of conductive pads, the number of multiple third conductive sheets included in the third plurality of conductive pads may be the same as that of the first plurality of conductive pads, and the number of multiple fourth conductive sheets included in the fourth plurality of conductive pads may be the same as that of the second plurality of conductive pads;
a second circuit board may be provided in the second connector, the second circuit board may be provided with at least a third plurality of conductive pads, and the number of multiple third conductive sheets included in the third plurality of conductive pads may be different from that of the first plurality of conductive pads;
the transmission line may be connected to at least one end of the first connector, and may have an extension axis direction which may be orthogonal to an extension axis direction of a mating direction of the first connector;
the transmission line may be connected to at least one end of the first connector, and may have an extension axis direction which may be the same as an extension axis direction of a mating direction of the first connector;
the transmission line may be connected to at least one end of the second connector, and may have an extension axis direction which may be orthogonal to an extension axis direction of a mating direction of the second connector;
the transmission line may be connected to at least one end of the second connector, and may have an extension axis direction which may be the same as an extension axis direction of a mating direction of the second connector; and
the first plurality of conductive pads may comprise 74 first conductive sheets, and the second plurality of conductive pads may comprise 2 to 6 second conductive sheets.

In another example, a circuit board for a connector may comprise a substrate; a first group of conductive pads; a second group of conductive pads disposed a same transverse axis position as the first group of conductive pads and separated from the first group of conductive pads by a first separation distance; and a third group of conductive pads disposed at a different transverse axis position from the first group of conductive pads and separated from the first group of conductive pads by a second separation distance. The second and third groups of conductive pads may be disposed at different transverse axis positions and may be separated from each other by a third separation distance. The third group of conductive pads may be electrically connected to the first group of conductive pads and the second group of conductive pads, respectively.

Such a circuit board optionally may include one or more of the following features or characteristics:
the first group of conductive pads may include a plurality of first conductive pads, and the first conductive pads may be arranged along the horizontal axis; the second group of conductive pads may include a plurality of second conductive pads. The second conductive pads may be arranged along the horizontal axis direction. The third group of conductive pads may include a plurality of third conductive pads, and the third conductive pads may be arranged along the horizontal axis direction;
the first separation distance, the second separation distance and the third separation distance may be respectively at least larger than any adjacent first conductive pads, any adjacent second conductive pad, and any adjacent third conductive pads;
the second separation distance may be substantially the same as the third separation distance;
a combined length of the first conductive pad group, the first separation distance, and the second group of conductive pads may be greater than a length of the third group of conductive pads;
interconnections between the groups of conductive pads may be embedded in the region of the substrate corresponding to the second separation distance and the third separation distance;
the first group of conductive pads may include 37 first conductive pads, the second group of conductive pads may include 1 to 3 second conductive pads, and the third group of conductive pads may include 38 to 40 third conductive pads;
the circuit board may include two first groups of conductive pads, two second groups of conductive pads and two third groups of conductive pads. The two first groups of conductive pads may be respectively arranged on opposite sides of the substrate, the two second groups of conductive pads may be respectively arranged on opposite sides of the substrate, and the two third groups of conductive pads may be respectively arranged on opposite sides of the substrate; and
each of the first groups of conductive pads may include 37 first conductive pads, each of the second groups of conductive pads may include 1 to 3 second conductive pads, and each of the third group of conductive pads may include 38 to 40 third conductive pads.

In another example, an electrical connector may comprise a housing comprising a slot elongated in a horizontal direction; a first terminal assembly disposed in the housing, the first terminal assembly comprising a plurality of first conductive elements, each of the plurality of first conductive elements comprising a mating portion in the slot, a tail portion extending out of the housing, and an intermediate portion between the mating portion and the tail portion; and a second terminal assembly disposed in the housing and aligned with and spaced from the first terminal assembly in the horizontal direction, the second terminal assembly comprising a plurality of second conductive elements, each of the plurality of second conductive elements comprising a mating portion in the slot, a tail portion extending out of the housing, and an intermediate portion between the mating portion and the tail portion.

Such an electrical connector optionally may include one or more of the following features or characteristics:
the first terminal assembly conforms to a first interface standard; and the second terminal assembly conforms to a second interface standard different from the first interface standard;
the second terminal assembly is spaced from the first terminal assembly in the horizontal direction by a center-to-center distance; and the center-to-center distance is greater than both a center-to-center pitch between adjacent first conductive elements and a center-to-center pitch between adjacent second conductive elements;
the center-to-center distance is no less than 4.13 mm;
the first terminal assembly comprises a first number of first conductive elements; and the second terminal assembly comprises a second number of second conductive elements different from the first number;
the first number is 37; and the second number is in the range of 1 to 3;
the first terminal assembly comprises an assembly housing holding the plurality of first terminals; the assembly housing of the first terminal assembly is disposed in the housing of the electrical connector; and the plurality of second terminals of the second terminal assembly are directly disposed in the housing of the electrical connector;
at least a part of the intermediate portion of each second conductive element of the second terminal assembly is disposed closer to a long side wall of the housing than a corresponding part of the intermediate portion of each first conductive element of the first terminal assembly;
the first terminal assembly is a first first terminal assembly disposed on a first side of the slot; the second terminal assembly is a first second terminal assembly disposed on the first side of the slot; and the electrical connector comprises a second first terminal assembly disposed on a second side of the slot opposite the first side, and a second second terminal assembly disposed on the second side of the slot and aligned with and spaced from the second first terminal assembly in the horizontal direction; and
the first and second first terminal assemblies are disposed in a first portion of the housing having a first width in a transverse direction perpendicular to the horizontal direction; the first and second second terminal assemblies are disposed in a second portion of the housing having a second width in the transverse direction; and a third portion of the housing has a third width in the transverse direction greater than both the first width and the second width.

In another example, a circuit board for an electrical connector may comprise a first group of conductive pads aligned in a horizontal direction; a second group of conductive pads aligned with and spaced from the first group of conductive pads in the horizontal direction; and a third group of conductive pads electrically coupled to respective conductive pads in the first and second groups.

Such a circuit board optionally may include one or more of the following features or characteristics:
the second group of conductive pads is spaced from the first group of conductive pads in the horizontal direction by a first distance; and a combined length of the first and second groups of conductive pads and the first distance is greater than a length of the third group of conductive pads in the horizontal direction;
the third group of conductive pads is spaced from the first group of conductive pads in a transverse direction perpendicular to the horizontal direction by a second distance and spaced from the second group of conductive pads in the transverse direction by the second distance;
the first group of conductive pads comprises a first number of conductive pads; and the second group of conductive pads comprises a second number of conductive pads in a range of 1 to 3; and
the first number is 37; and the third group of conductive pads comprise a third number of conductive pads in a range of 38 to 40.

In another example, a cable assembly may comprise a circuit board described herein; and a cable comprising a plurality of wires each attached to a respective one of the third group of conductive pads.

In another example, an active cable may comprise a cable comprising a plurality of wires extending from a first end to a second end; a first circuit board disposed at the first end of the cable, the first circuit board comprising a first group of contact pads aligned in a first row, a second group of contact pads aligned in the first row with the first group of contact pads and separated from the first group of contact pads by a space, and a third group of contact pads disposed in a second row physically connected to the plurality of wires; and a second circuit board disposed at the second end of the cable, the second circuit board comprising a control chip and a plurality of contact pads electrically coupled to the control chip and physically connected to the plurality of wires.

Such a circuit board optionally may include one or more of the following features or characteristics:
the first circuit board extends in parallel to the second circuit board;
the first circuit board extends in orthogonal to the second circuit board; and
for the first circuit board: the second row extends in orthogonal to the first row.

It should be understood that various alterations, modifications, and improvements may be made to the structures, configurations, and methods discussed above, and are intended to be within the spirit and scope of the disclosure disclosed herein. Further, although advantages of the present disclosure are indicated, it should be appreciated that not every embodiment of the disclosure will include every described advantage. Some embodiments may not implement any features described as advantageous herein. Accordingly, the foregoing description and attached drawings are by way of example only.

It should be understood that some aspects of the present disclosure may be embodied as one or more methods, and acts performed as part of a method of the present disclosure may be ordered in any suitable way. Accordingly, embodiments may be constructed in which acts are performed in an order different than shown and/or described, which may include performing some acts simultaneously, even though shown and/or described as sequential acts in various embodiments.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the description and the claims to modify an element does not by itself connote any priority, precedence, or order of one element over another, or the temporal order in which acts of a method are performed, but are used merely as labels to distinguish one element or act having a certain name from another element or act having a same name (but for use of the ordinal term) to distinguish the elements or acts.

In addition, directional terms may be mentioned in connection with various embodiments, such as, e.g., “upper,” “lower,” “front,” “rear,” “left,” “right,” etc., and may refer to directions in the drawings. These directional terms used are for purposes of illustration and are not intended to limit the scope of the present disclosure of the scope of the claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by +5%.

The phrase “and/or,” as used herein in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. Use of terms such as “including,” “comprising,” “comprised of,” “having,” “containing,” and “involving,” and variations thereof herein, is meant to encompass the items listed thereafter and equivalents thereof as well as additional items. The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

What is claimed is:

1. An electrical connector comprising:
a housing comprising a slot elongated in a horizontal direction;
a first terminal assembly disposed in the housing, the first terminal assembly comprising a plurality of first conductive elements, each of the plurality of first conductive elements comprising a mating portion in the slot, a tail portion extending out of the housing, and an intermediate portion between the mating portion and the tail portion; and
a second terminal assembly disposed in the housing and aligned with and spaced from the first terminal assembly in the horizontal direction, the second terminal assembly comprising a plurality of second conductive elements, each of the plurality of second conductive elements comprising a mating portion in the slot, a tail portion extending out of the housing, and an intermediate portion between the mating portion and the tail portion.

2. The electrical connector of claim 1, wherein:
the first terminal assembly conforms to a first interface standard; and
the second terminal assembly conforms to a second interface standard different from the first interface standard.

3. The electrical connector of claim 1, wherein:
the second terminal assembly is spaced from the first terminal assembly in the horizontal direction by a center-to-center distance; and
the center-to-center distance is greater than both a center-to-center pitch between adjacent first conductive elements and a center-to-center pitch between adjacent second conductive elements.

4. The electrical connector of claim 3, wherein:
the center-to-center distance is no less than 4.13 mm.

5. The electrical connector of claim 1, wherein:
the first terminal assembly comprises a first number of first conductive elements; and
the second terminal assembly comprises a second number of second conductive elements different from the first number.

6. The electrical connector of claim 5, wherein:
the first number is 37; and
the second number is in a range of 1 to 3.

7. The electrical connector of claim 1, wherein:
the first terminal assembly comprises an assembly housing holding the plurality of first terminals;
the assembly housing of the first terminal assembly is disposed in the housing of the electrical connector; and
the plurality of second terminals of the second terminal assembly are directly disposed in the housing of the electrical connector.

8. The electrical connector of claim 1, wherein:
at least a part of the intermediate portion of each second conductive element of the second terminal assembly is disposed closer to a long side wall of the housing than a corresponding part of the intermediate portion of each first conductive element of the first terminal assembly.

9. The electrical connector of claim 1, wherein:
the first terminal assembly is a first first terminal assembly disposed on a first side of the slot;
the second terminal assembly is a first second terminal assembly disposed on the first side of the slot; and
the electrical connector comprises a second first terminal assembly disposed on a second side of the slot opposite the first side, and a second second terminal assembly disposed on the second side of the slot and aligned with and spaced from the second first terminal assembly in the horizontal direction.

10. The electrical connector of claim 9, wherein:
the first and second first terminal assemblies are disposed in a first portion of the housing having a first width in a transverse direction perpendicular to the horizontal direction;
the first and second second terminal assemblies are disposed in a second portion of the housing having a second width in the transverse direction; and
a third portion of the housing has a third width in the transverse direction greater than both the first width and the second width.

11. A circuit board for an electrical connector comprising:
a first group of conductive pads aligned in a horizontal direction;
a second group of conductive pads aligned with and spaced from the first group of conductive pads in the horizontal direction; and
a third group of conductive pads electrically coupled to respective conductive pads in the first and second groups.

12. The circuit board of claim 11, wherein:
the second group of conductive pads is spaced from the first group of conductive pads in the horizontal direction by a first distance; and
a combined length of the first and second groups of conductive pads and the first distance is greater than a length of the third group of conductive pads in the horizontal direction.

13. The circuit board of claim 12, wherein:
the third group of conductive pads is spaced from the first group of conductive pads in a transverse direction perpendicular to the horizontal direction by a second distance and spaced from the second group of conductive pads in the transverse direction by the second distance.

14. The circuit board of claim 12, wherein:
the first group of conductive pads comprises a first number of conductive pads; and
the second group of conductive pads comprises a second number of conductive pads in a range of 1 to 3.

15. The circuit board of claim 14, wherein:
the first number is 37; and
the third group of conductive pads comprise a third number of conductive pads in a range of 38 to 40.

16. A cable assembly comprising:
the circuit board of claim 11; and
a cable comprising a plurality of wires each attached to a respective one of the third group of conductive pads.

17. An active cable comprising:
a cable comprising a plurality of wires extending from a first end to a second end;
a first circuit board disposed at the first end of the cable, the first circuit board comprising a first group of contact pads aligned in a first row, a second group of contact pads aligned in the first row with the first group of contact pads and separated from the first group of contact pads by a space, and a third group of contact pads disposed in a second row physically connected to the plurality of wires; and
a second circuit board disposed at the second end of the cable, the second circuit board comprising a control chip and a plurality of contact pads electrically coupled to the control chip and physically connected to the plurality of wires.

18. The active cable of claim 17, wherein:
the first circuit board extends in parallel to the second circuit board.

19. The active cable of claim 17, wherein:
the first circuit board extends in orthogonal to the second circuit board.

20. The active cable of claim 17, wherein, for the first circuit board:
the second row extends in orthogonal to the first row.
